(19) United States
(12) Patent Application Publication
(10) Pub. No.: US 2025/0277587 A1
(43) Pub. Date: Sep. 4, 2025

(54) NRED OVEN DEVICE

(71) Applicant: PTI IP LLC, Cleveland, OH (US)

(72) Inventors: Don W. COCHRAN, Gates Mills, OH (US); Mark F. FLEMING, Strongsville, OH (US); Steven D. CECH, Richfield, OH (US)

(73) Assignee: PTI IP LLC, Cleveland, OH (US)

(21) Appl. No.: 18/592,989

(22) Filed: Mar. 1, 2024

(51) Int. Cl. F24C 7/04; H05B 3/00

(52) U.S. Cl. CPC F24C 7/046; H05B 3/0076; H05B 2203/032

(57) ABSTRACT

A system is provided to configure and optimize a systemically approached NRED oven. Features disclosed are advantageous and very desirable to achieve the objective of creating a fully functional NRED oven system. The unique configuration of all or nearly all of these later-to-be-described elements, will enable the construction of a fully functional NRED oven that is robust, flexible in applications, and has substantial functional life in real life cooking, heating, drying, thawing, and curing applications. The system, in at least one form, provides a configuration that results in a robust and fully functional NRED oven, configured uniquely to fill a strong market need and prevent premature system or device failure.

### BACKGROUND

Mankind has been cooking its food for about 6,000 years. The very earliest cooking was done directly with flame or indirectly from things heated by flame. To induce the flames, common combustibles such as wood and animal products were used. In the late 1800's, alternative combustibles were used such as oil, natural gas, propane, and coal. These alternative combustibles were more suitable for people's lifestyle, especially for more urban lifestyles which were becoming more commonplace at that time.

All combustion, including with the fuels mentioned above, produce a broadband heat output. That is, there is substantial photonic energy output which is spread into a range of several thousand nanometers of bandwidth. The output of this heat energy takes the form of a broad gaussian curve which extends from the visible spectrum into and through the near, the mid, and far infrared. The peak of this gaussian curve can vary depending on the combustible and the conditions under which they are burned, but the output intensity curves typically have long and significant “tails” of output well through the mid IR and long IR wavelengths. Although most, but not all, broadband energy sources have some visible component, the peak can vary from around one thousand nanometers to well into the five or six thousand nanometer ranges or above. The wavelength output curve of any broadband heat source is directly definable as a function of the temperature of an equivalent temperature blackbody, which formulation and calculations can be found in most physics textbooks.

As the world became more industrialized, there were also more needs for heating and curing various things as part of higher production manufacturing processes. Similar heat sources were used to produce the broadband heat energy that were used for these purposes. Some heating and curing was done with open, direct application of flames or the heat source while some was accomplished in fully or partially enclosed ovens of varying configurations.

While substantial photonic heat energy is available from any of these sources, they all have substantial output over a very wide range of wavelengths and are thus referred to as broadband sources. In the late 1800's, electric heating sources were invented and began to be used increasingly widely through the twentieth century. Resistive heating elements, which are often called by a common brand name of calrods, are broadly used to produce electrically sourced heat. Quartz lamps, high and low intensity discharge lamps, and a range of various types of arc devices are also commonly used electric heat sources to produce heat for various applications. All of these mentioned sources of heat production which can be used for cooking, curing, thawing, drying, heating, or holding, produce their photonic heat energy in a broadband form. This wide output spectrum is an advantage in some applications but a decided disadvantage in others.

Some additional background reveals that in the 1950's, it was realized that technology that had been developed for WWII radar, was useful for heating, warming, and cooking food as well as for warming other objects. It was recognized that high intensity radio frequency energy, also known as RF energy, would resonate with the water molecules in food and spin them, thus creating heat. The water molecule is considered a polar molecule which, when it spins and/or reciprocates around the oxygen atom, will cause water to boil or steam-out of the target item very quickly. It is well known that virtually all types of naturally occurring food, both animal and vegetable comestibles, have from 55%-95% water as the major component of their composition. For example, haddock fish is 79.92%, beef brisket is 55.18%, lean sirloin is 71.7%, olives are 79.99%, spinach is 91.58%, green peas are 78.86%, yams are 69.9%, cranberries are 86.57%, bananas are 74.26%, shrimp are 75.86%, turkey is 70.4%, and whole milk is 87.69% water. A notable exception is that nuts of all types are less than 7% water. As the water boils in the food, the steam pressure forces it out of the food thus drying it out.

This radio frequency band was later deemed “microwaves” because they were substantially smaller than the radio waves that were often employed for radio communications at the time. Whereas microwaves are actually quite large when compared to the wavelength of visible or even near infrared light or photonic energy.

Modern kitchen microwave ovens operate at a frequency of 2.45 gigahertz with a wavelength of 12.2 centimeters (4.8 inches). The fact that microwaves are so physically large is a great surprise when most people first learn of it. It is easy to understand why, for such a long wavelength, standing waves can be created within the cooking cavity which can partially or completely nullify, cancel, or contribute to the wave strength at any given spot within the three-dimensional cavity that comprises the oven interior. These standing wave and resonance reflections cause the well-known cold and hot spots in food cooked in microwave or RF ovens. Often, microwave ovens incorporate rotating turntables or moving reflectors in the oven cavity in an attempt to minimize the standing waves or cold/hot spots. This treatment does not go very far to eliminate the problem and in many cases can even make it worse.

### SUMMARY

In accordance with one aspect of the present exemplary embodiments, an oven system for curing, cooking, heating, thawing or holding at temperature, the system being designed to provide an irradiation location to heat at least one of a target item or comestible comprises at least one array of narrowband radiation emitting devices (NREDs) configured to produce at least 6 watts per square inch of infrared energy measured at a target plane, the at least one array of NREDs supplying at least 6 watts per square inch of optical energy to each of at least 12 square inches of the target plane, wherein at least one of the NREDs is provided with a corresponding lens or engineered reflector and wherein at least one of the NREDs in the at least one array produces narrowband photonic output between 720 and 1180 nanometers, a substrate upon which the at least one array of NREDs is mounted, the at least one array of NREDs being arranged on the substrate formed of a thermally transmissive material, wherein the material has an index of thermal conductivity of at least 160 W/mK, circuit traces formed on the substrate, the NREDs being soldered to the traces, wherein the traces dissipate heat generated by the NREDs soldered to the traces, a structure configured to hold the at least one array of NREDs and the substrate upon which the at least one array of NREDs is mounted in a predetermined position in the system and to provide a platform to support the target or comestible item for irradiation, a protective plate formed of at least one of glass, plastic, or transmissive ceramic material and being positioned between the target item or comestible and the at least one array of NREDs and one of the corresponding lenses and the engineered reflectors, wherein the protective plate is at least 85% optically transmissive at the wavelength produced by the NRED devices, and wherein the protective plate includes a sealing element around a perimeter of the protective plate arranged to cooperate with the structure to seal out contaminants from reaching the at least one NRED array and the corresponding lenses, an air movement space between the protective plate and any of the at least one array of NREDs, the circuit board substrate, and one of the corresponding lenses and the engineered reflectors to provide a path for removal of heat from the at least one array of NREDs, at least one fan positioned to generate air flow to remove heat from any of the at least one array of NREDs, the circuit board substrate, the corresponding lenses, and the air space, and, a control system operatively connected to at least one DC power supply, the at least one DC power supply being operatively connected to the at least one array of NREDs and capable of continuously controlling the amperes of electrical current being supplied thereto or a power supply which is used in conjunction with at least one electrical component which limits the current to the at least one array of NREDs.

In accordance with another aspect of the present exemplary embodiments, the corresponding lens is an array of lenses which are arranged in an engineered micro-lens array whose spacing corresponds to the spacing of the NRED devices of the array and which can steer the energy according to a desired energy distribution pattern.

In accordance with another aspect of the present exemplary embodiments, the corresponding lenses are formed integrally to each NRED device and focus the output to approximately one of a 70 degree angle, a 60 degree angle, a 50 degree angle, a 40 degree angle, a 30 degree angle and a 10 degree angle.

In accordance with another aspect of the present exemplary embodiments, the oven is configured to position at least two stacks, each stack comprising the at least one array, the substrate, the protective plate and the at least one fan, on at least two sides or top and bottom of the irradiation platform to facilitate irradiation from two approximately opposite directions, facilitating using less power from each direction but providing better distribution through the target item or comestible item.

In accordance with another aspect of the present exemplary embodiments, the circuit traces are provided on the substrate such that dimensions of the circuit traces are enlarged in the large plane of the substrate to a maximum practical extent before the circuit traces cause shorting to neighboring traces, in order to spread and dissipate heat produced by the NREDs more quickly and directly from a soldered base of each device.

In accordance with another aspect of the present exemplary embodiments, the system comprises multiple substrates, each substrate having at least one array of NREDs mounted thereon defining a circuit board, the circuit boards being designed so that the circuit boards can be mounted side-by-side to facilitate at least one of array mounting symmetry, minimize non-homogeneity in target plane power, and zone positioning flexibility, such that the circuit boards would be configured accordingly in both the x and y directions as relates to the large plane of each respective circuit board.

In accordance with another aspect of the present exemplary embodiments, when multiple circuit boards with heatsinks are used, the circuit boards are designed so that they can be mounted side-by-side to facilitate at least one of array mounting symmetry, minimize non-homogeneity in target plane power, and zone positioning flexibility, such that the circuit boards would be configured accordingly in both the x and y directions as relates to the large plane of each respective circuit board.

In accordance with another aspect of the present exemplary embodiments, wherein a majority of the NREDs produce their narrowband output between 720 and 1180 nanometers but at least one NRED are incorporated which produce their narrowband output between 1360 and 1560 nanometers in order to be absorbed nearer the surface of a comestible target.

In accordance with another aspect of the present exemplary embodiments, wherein at least one NRED are incorporated which produce their narrowband output between 1360 and 1560 nanometers in order to be absorbed nearer the surface of a comestible target.

In accordance with another aspect of the present exemplary embodiments, the reflective surfaces are configured to direct stray irradiation to the target item and corner cube reflectors to redirect irradiation reflected from the target item back to the target item.

In accordance with one aspect of the present exemplary embodiments, the at least one array of NREDs comprises one of two arrays of NREDs, four arrays of NREDs, six arrays of NREDs or eight arrays of NREDs.

In accordance with another aspect of the present exemplary embodiments, each of the at least one array of NREDs is controlled by a different current to provide varying amounts of power.

In accordance with another aspect of the present exemplary embodiments, the stack comprises the at least one array, the substrate, the protective plate and the at least one fan, wherein the stack is mounted above a heating zone, wherein the structure provides a space below for the comestible, and wherein irradiation is aimed generally downward such that the irradiation is absorbed by the comestible directly so as to not pass through any plating item on which the comestible is placed before hitting the comestible.

In accordance with another aspect of the present exemplary embodiments, the 12 square inches of target plane comprises 12 contiguous square inches.

In accordance with another aspect of the present exemplary embodiments, the DC power supply is comprised of a battery which is recharged from one of an alternating current source and a solar panel arrangement.

In accordance with another aspect of the present exemplary embodiments, the oven system is configured to produce one of at least 20 Watts/Square Inch, 40 Watts/Square Inch, 60 Watts/Square Inch, or 100 Watts/Square Inch at the target plane.

In accordance with one aspect of the present exemplary embodiments, the oven system is configured to produce one of at least 60 Watts/Square Inch, 100 Watts/Square Inch, 120 Watts/Square Inch, or 140 Watts/Square Inch to at least 20 contiguous square inches of the target plane.

In accordance with another aspect of the present exemplary embodiments, an oven system for curing, cooking, heating, thawing or holding at temperature, the system being designed to provide an irradiation location to heat at least one of a target item or comestible, the system comprises at least one array of narrowband radiation emitting devices (NREDs) configured to produce at least 6 watts per square inch of narrowband infrared energy at a target plane, wherein the at least one array of NREDs supplying at least 6 watts per square inch of narrowband infrared energy to each of at least 12 square inches of the target plane, wherein at least one of the NREDs is provided with a corresponding lens or engineered reflector and wherein at least one of the NREDs in the at least one array produces peak narrowband infrared energy output between 720 and 1180 nanometers, at least one heatsink, in lieu of a separate circuit board, upon which the at least one array of NREDs is mounted, wherein the at least one heatsink material has a thermal coefficient of conductivity of at least 205 W/mK, wherein the at least one heatsink is at least ten times the mass of the separate circuit board, wherein the at least one heatsink provides substantially increased surface area compared to a surface of a separate circuit board thereby providing much more heat absorption and dissipation and facilitating more surface area for radiant cooling to surrounding ambient air and wherein a surface of the at least one heatsink which is used for mounting the NREDs is a substantially flat surface and has been coated with an electrically insulative but thermally conductive coating, circuit traces applied directly to a surface of the electrically insulative but thermally conductive coating, the NREDs being soldered directly to the circuit traces, wherein the traces are thermally conductive and dissipate heat generated by the NREDs soldered to the traces on the substrate, a structure configured to hold the at least one array of NREDs and the heatsink upon which the at least one array of NREDs is mounted in a predetermined position in the system and to provide a platform to support the target or comestible item for irradiation, a protective plate formed of at least one of glass, plastic, or transmissive ceramic material and being positioned between the target item or comestible and the at least one array of NREDs and corresponding lenses, wherein the protective plate is at least 82% optically transmissive at the wavelength produced by the NRED devices, and wherein the protective plate includes a sealing element around a perimeter of the protective plate arranged to cooperate with the structure to seal out contaminants from reaching the at least one NRED array and the corresponding lenses, an air movement space between the protective plate and the at least one array of NREDs and one of the corresponding lenses and the engineered reflectors to provide a path for removal of heat from the at least one array of NREDs, at least one fan positioned to generate air flow to remove heat from at least one of the array of NREDs, the circuit substrate, and one of the corresponding lenses and the engineered reflectors, and, a control system operatively connected to at least one DC power supply, the at least one DC power supply being operatively connected to the at least one array of NREDs and capable of continuously controlling the amperes of electrical current being supplied thereto or a power supply which is used in conjunction with at least one electrical component which limits the current to the at least one array of NREDs.

In accordance with another aspect of the present exemplary embodiments, the corresponding lens is comprised of in an engineered micro-lens array providing the functionality of steering the energy from many of the respective NRED devices to form an overall desired energy distribution pattern.

In accordance with another aspect of the present exemplary embodiments, corresponding lens is comprised of an integrally formed lens to many of the narrowband radiation emitting devices and focus the respective device's output to one of approximately: a 70 degree angle, a 60 degree angle, a 50 degree angle, a 40 degree angle, a 30 degree angle and a 10 degree angle.

In accordance with another aspect of the present exemplary embodiments, the protective plate is made of borosilicate glass and includes an anti-reflective coating on both sides such that transmissivity is at least 98%.

In accordance with another aspect of the present exemplary embodiments, the electrically insulative but thermally conductive coating that is applied on the at least one heatsink is one of aluminum nitride, diamond-like coating, and diamond coating for extreme heat conduction of the heat from the NRED devices wherein the thermal conductivity of the coating is greater than 300 W/mK.

In accordance with another aspect of the present exemplary embodiments, the protective plate integrates with the structure and sidewalls of the oven system to seal out contaminants so the contaminants cannot reach any of the at least one array of NREDs, circuit traces, the corresponding lenses, power supplies and other sensitive components, and such that there is a drain arrangement associated with the protective plate to carry away liquid contaminants.

In accordance with another aspect of the present exemplary embodiments, the oven is configured to position at least two stacks, each stack comprising the at least one array, the at least one heatsink, the protective plate and the at least one fan, on at least two sides or top and bottom of the irradiation platform to facilitate irradiation from two approximately opposite directions, facilitating using less power from each direction but providing better distribution through the target item or comestible item.

In accordance with another aspect of the present exemplary embodiments, the oven is configured such that the structure includes sidewalls which are strategically angled and the sidewalls are strategically covered with at least one of corner cube reflection sheet or approximate corner cube reflection sheet, the angles and configuration of which are arranged for efficient return of reflected or scattered energy that has come from the target but is reflected back to the target item, and which corner-cube reflection sheet is provided with a smooth surface facing the target item to provide for ease of cleaning.

In accordance with another aspect of the present exemplary embodiments, at least one NRED array is provided with one of a corner cube sheet or a reflective sheet with holes provided through which the NRED devices can project energy and provide for efficient reflection of NRED optical energy, originally directed to the target item or comestible then reflected away, back to the target item to increase overall heating efficiency.

In accordance with another aspect of the present exemplary embodiments, the circuit traces are provided on the heatsink such that dimensions of the circuit traces are enlarged in the large plane of the heatsink to a maximum practical extent before the circuit traces cause shorting to neighboring traces, in order to spread and dissipate heat produced by the NREDs quickly and directly from a soldered base of each device.

In accordance with another aspect of the present exemplary embodiments, the at least one heatsink comprises multiple heatsinks, each heat sink having at least one array of NREDs mounted thereon, the heatsinks being designed so that the heatsinks can be mounted side-by-side to facilitate at least one of array mounting symmetry, minimize non-homogeneity in target plane power, and zone positioning flexibility, such that the heatsinks would be configured accordingly in both the x and y directions as relates to the large plane of each respective heatsink.

In accordance with another aspect of the present exemplary embodiments, a majority of the NREDs produce their narrowband output between 720 and 1180 nanometers but at least one NRED are incorporated which produce their narrowband output between 1360 and 1560 nanometers in order to be absorbed nearer the surface of a comestible target.

In accordance with another aspect of the present exemplary embodiments, the NREDs that produce their narrowband output between 1360 and 1560 are mounted in such a manner that their output can be one of scanned over the surface of the comestible and directed to the comestible target differently than the other narrowband NRED devices.

In accordance with another aspect of the present exemplary embodiments, the system is configured such that the target item can be moved through the irradiation platform zone for irradiation.

In accordance with another aspect of the present exemplary embodiments, completely different sequential digital irradiation programs can be delivered from each NRED array or section of an array.

In accordance with another aspect of the present exemplary embodiments, at least one NRED are incorporated which produce their narrowband output between 1360 and 1560 nanometers in order to be absorbed nearer the surface of a comestible target.

In accordance with another aspect of the present exemplary embodiments, reflective surfaces are configured to direct stray irradiation to the target item and corner cube reflectors to redirect irradiation reflected from the target item back to the target item.

In accordance with another aspect of the present exemplary embodiments, the at least one array of NREDs comprises one of two arrays of NREDs, four arrays of NREDs, six arrays of NREDs or eight arrays of NREDs.

In accordance with another aspect of the present exemplary embodiments, each of the at least one array of NREDs is controlled by a different current to provide varying amounts of power.

In accordance with another aspect of the present exemplary embodiments, the 12 square inches of target plane comprises 12 contiguous square inches.

In accordance with another aspect of the present exemplary embodiments, the DC power supply is comprised of a battery which is recharged from one of an alternating current source and a solar panel arrangement.

In accordance with another aspect of the present exemplary embodiments, the circuit traces are enlarged in thickness and substantially beyond the footprint of the NRED devices to provide additional heat dissipation such that traces are enlarged to within 0.050″ of neighboring traces.

In accordance with another aspect of the present exemplary embodiments, there is a gutter drainage arrangement that is adjacent to at least part of a perimeter of the protective plate and provides a path that gravity can use to drain away to a safe area any liquid contaminant that might be on the surface of the protective plate.

In accordance with another aspect of the present exemplary embodiments, an oven system for curing, cooking, thawing or heating, the system being designed to provide an irradiation platform location to heat at least one of a target item or comestible, comprises at least one array of narrowband radiation emitting devices (NREDs) configured to produce at least 6 watts per square inch of infrared energy measured at a target plane, the at least one array of NREDs supplying at least 6 watts per square inch of optical energy to each of at least 12 square inches of the target plane, wherein at least one of the NREDs is provided with a corresponding lens or engineered reflector and wherein at least one of the NREDs in the at least one array produces narrowband photonic output between 720 and 1180 nanometers, a substrate upon which the at least one array of NREDs is mounted, the at least one array of NREDs being arranged on the substrate formed of a thermally transmissive material, wherein the material has an index of thermal conductivity of at least 160 Watts/K-Meter, wherein the substrate has a dielectric material thereon, circuit traces formed on the substrate, the circuit traces being insulated from the substrate by dielectric material, the NREDs being soldered to the traces, and the traces being configured to dissipate heat generated by the NREDs soldered to the traces, a heatsink having at least ten times the mass of the substrate, wherein the heatsink is intimately in contact with and is sized similarly to a bottom of the substrate, an interface between the heatsink and the substrate being coated with thermal grease to increase a thermal conduction into the heatsink, wherein the heatsink is formed of a material having a thermal coefficient of conductivity of at least 205 Watts/K-Meter and wherein the heatsink provides the system with substantially increased surface area, for more heat absorption and dissipation and facilitating more surface area for radiant cooling to surrounding ambient air, a structure configured to hold the at least one array of NREDs, the substrate upon which the at least one array of NREDs is mounted, and the heatsink in a predetermined position in the system and to provide a platform to support the target or comestible item for irradiation, a protective plate formed of at least one of glass, plastic, or transmissive ceramic material and being positioned between the target item or comestible and the at least one array of NREDs and corresponding lenses, wherein the protective plate is at least 88% optically transmissive at the wavelength produced by the NRED devices, and wherein the protective plate includes a sealing element around a perimeter of the protective plate arranged to cooperate with the structure to seal out contaminants from reaching the at least one NRED array and the corresponding lenses, an air space between the protective plate and the at least one array of NREDs and the corresponding lenses to provide a path for removal of heat from the at least one array of NREDs, at least one fan positioned to generate air flow to remove heat from at least one of array of NREDs, the substrate, the corresponding lenses, and the air space, wherein the at least one fan is positioned to generate air flow through surface-area-increasing turbulation channels in the heatsink and through the air space to remove heat produced by the at least one NRED array, and, a control system operatively connected to at least one DC power supply, the at least one DC power supply being operatively connected to the at least one array of NREDs and capable of continuously controlling the amperes of electrical current being supplied thereto or a power supply which is used in conjunction with at least one electrical component which limits the current to the at least one array of NREDs.

In accordance with another aspect of the present exemplary embodiments, the system is configured with more than one NRED array and each NRED array can be controlled separately and may be aimed at a target area zone that is one of the same area, partially overlapping areas, and completely different areas.

In accordance with another aspect of the present exemplary embodiments, different power levels can be delivered to different zones from either whole NRED arrays or sub-sections of NRED arrays to achieve desired results in each zone.

In accordance with another aspect of the present exemplary embodiments, completely different sequential digital irradiation programs can be delivered from each NRED array.

In accordance with another aspect of the present exemplary embodiments, the oven system is configured to produce one of at least 40 Watts/square inch, 60 Watts/Square Inch, 100 Watts/Square Inch, 120 Watts/Square Inch, or 140 Watts/Square Inch to at least 20 square inches of target area.

In accordance with another aspect of the present exemplary embodiments, the oven system is configured to position two stacks, each stack comprising the at least one array, the circuit board substrate, the heatsink, the protective plate and the at least one fan, on at least two sides of the irradiation platform to facilitate irradiation from two or more directions, which could be top and bottom or could be side to side or another direction, but facilitating irradiation from at least two directions, providing better distribution through the target or comestible item and providing that a different amount of energy can be delivered from each side.

In accordance with another aspect of the present exemplary embodiments, the circuit traces for each respective NRED are enlarged substantially beyond the footprint of the NRED devices to provide additional heat dissipation and such that some of the traces are enlarged to within 0.050″ of a neighboring trace.

In accordance with another aspect of the present exemplary embodiments, there is a gutter drainage arrangement adjacent to at least part of a perimeter of the protective plate and provides a path, that gravity can use to drain away to a safe area, any liquid contaminant that might be on the surface of the protective plate.

In accordance with another aspect of the present exemplary embodiments, the protective plate is made of borosilicate glass and has been anti-reflective coated on both sides such that transmissivity is at least 98%.

In accordance with another aspect of the present exemplary embodiments, a majority of the NREDs produce their narrowband output between 720 and 1180 nanometers but at least one NRED devices are incorporated which produce their narrowband output between 1360 and 1560 nanometers in order to be absorbed nearer the surface of a comestible target.

In accordance with another aspect of the present exemplary embodiments, the protective plate is made of borosilicate glass and includes an anti-reflective coating on both sides such that transmissivity is at least 98%.

In accordance with another aspect of the present exemplary embodiments, completely different sequential digital irradiation programs can be delivered from each NRED array or section of an array.

In accordance with another aspect of the present exemplary embodiments, at least one NRED devices are incorporated which produce their narrowband output between 1360 and 1560 nanometers in order to be absorbed nearer the surface of a comestible target.

In accordance with another aspect of the present exemplary embodiments, reflective surfaces are configured to direct stray irradiation to the target item and corner cube reflectors to redirect irradiation reflected from the target item back to the target item.

In accordance with another aspect of the present exemplary embodiments, the at least one array of NREDs comprises one of two arrays of NREDs, four arrays of NREDs, six arrays of NREDs or eight arrays of NREDs.

In accordance with another aspect of the present exemplary embodiments, each of the at least one array of NREDs is controlled by a different current to provide varying amounts of power.

In accordance with another aspect of the present exemplary embodiments, the oven system is configured such that the at least 12 square inches to which is delivered the narrowband infrared energy is at least 40 contiguous square inches of target plane area.

In accordance with another aspect of the present exemplary embodiments, the oven system is configured to circulate water through the heatsink as an alternate way of providing enough cooling to the NRED devices.

In accordance with another aspect of the present exemplary embodiments, the 12 square inches of target plane comprises 12 contiguous square inches.

### DRAWINGS

FIG. 1 illustrates molecular activity;

FIG. 2 (a) illustrates an example implementation according to the presently described embodiments;

FIG. 2 (b) illustrates an example implementation according to the presently described embodiments;

FIG. 3 (a) and FIG. 3 (b) illustrate an example implementation according to the presently described embodiments;

FIG. 3 (c) illustrates an example implementation according to the presently described embodiments;

FIG. 4 (a) illustrates an example implementation according to the presently described embodiments;

FIG. 4 (b) illustrates an example implementation according to the presently described embodiments;

FIG. 4 (c) illustrates an example implementation according to the presently described embodiments;

FIG. 4 (d) and FIG. 4 (e) illustrate an example implementation according to the presently described embodiments;

FIG. 4 (f) illustrates an example implementation according to the presently described embodiments;

FIG. 5 illustrates an example implementation according to the presently described embodiments; and,

FIG. 6 illustrates an example implementation according to the presently described embodiments.

### DETAILED DESCRIPTION

In cooking, curing, thawing, and holding applications, for example, broadband sources have some serious limitations and shortcomings. U.S. Pat. Nos. 7,220,378, 7,425,296, 10,857,722 and 11,072,094 teach the advantages of using narrowband devices to “hit” specific absorptive and desirable wavelengths in food which cannot be hit without also hitting the adjacent wavelengths with broadband sources. For example, if it is determined that a particular food item has deep absorption at 1100 nanometers wavelength but quickly burns at 1500 nanometers' wavelength, a high intensity broadband source cannot be used to affect high-speed deep-penetration cooking because it will also provide high-speed burning of the food item.

While the aforementioned patents teach the use of the different specific narrowband wavelengths for the various purposes and advantages, the presently described embodiments relate to advantageous variations and implementations of narrowband technology to achieve, in at least one form, an oven having a rich mix of novel elements that is commercially practical and economical.

In this regard, within the last fifty years, narrowband semiconductor devices have been invented and sophisticated in the marketplace. The power output of these devices has continued to grow substantially since their introduction. Devices which at their original introduction might have produced only several milliwatts of photonic power output, were improved over some number of years to be five to forty milliwatts, and currently higher-powered devices are available which produce ten to fifty times the power of which the best original devices were capable. Some single light emitting diode (LED) devices, which devices are sometimes called radiation or radiance emitting devices (REDs) for infrared output, can currently produce from one to ten watts of optical photonic power. Laser diodes can still put out substantially more photonic energy and in a much narrower wavelength envelope than LEDs, but they are both growing substantially in power output capability. It is beyond the scope of this teaching to exhaustively detail the various kinds of LEDs/RED's and laser diodes that are currently available, but the offerings are growing every year and they are more powerful and useful than their predecessors.

Both laser diodes and LEDs should rightly be considered narrowband output devices. The “full width, at half max” output of laser diodes would typically be less than plus or minus ten nanometers from the nominal center wavelength. Some wavelength stabilized devices such as surface emitting distributed feedback devices (SEDFBs) and vertical cavity surface emitting laser devices (VCELs) can produce the vast majority of their photonic output within plus or minus one or two nanometers. LEDs are wider in output and can vary with various designs but are typically less than plus or minus twenty to fifty nanometers. It is possible to manufacture LEDs with broader output ranges but, for most designs, they still should be considered to be narrowband devices for the purposes of this teaching. The various types of both laser diodes and LEDs will be considered and referred to as NREDs for the balance of this document. That is simply an acronym standing for narrowband radiance or radiation emitting diode or device, or NRED (NREDs for plural).

There are three broad categories of laser diode devices. Devices from any of the categories could be used to implement the presently described embodiments, but two of the types have decided advantages over the other. The broad categories are as follows: edge emitting laser diodes, vertical cavity surface emitting diodes (VCELS), and surface emitting distributed feedback devices (SEDFB). Edge emitting laser diodes are typically mounted such that the long dimension of each device, is mounted perpendicular to an edge of the circuit board. They have a very small aperture on one end of the device, which end must be mounted flush and parallel to the edge of the circuit board. The photonic energy is emitted through the tiny aperture in the end of the device which is very vulnerable to various types of damage. Overheating and/or contaminants are the common cause of failure of the devices and it is generally referred to as catastrophic aperture failure of the devices. There are many different types and versions of edge emitters, but they all have a similar Achilles heel failure mechanism. The aperture out of which the photonic energy is emitted is very small and very vulnerable to contamination of any type or overheating from any cause. Catastrophic facet failure is a major weakness for these edge emitting devices, so it constrains the design flexibility of the devices. They must be kept in an enclosure that will protect against contamination and they must be carefully monitored to make sure that they are staying cool to protect them from failure. In order to protect the fragile and tiny facet, they must be precisely mounted along the edge of a circuit board to maintain the acceptable operating temperature of the device and of the facet. The facets must be shielded and protected if not hermetically sealed to prevent contaminants from landing on the facet and causing overheating and catastrophic failure. The designer of a system that uses edge emitters must deal with the challenge of somehow coupling the photonic output to the use and directing the energy accordingly. A wide range of creative lensing and packaging have been derived by the implementers of edge emitting devices. Lensing and engineered reflectors to form the output into the pattern of irradiation that is desired for a given application. Often the output facets of edge emitters are directed into a fixed position fiber optic, a challenging production problem, but it is often necessary and serves to deliver the energy. These fibers are often in parallel with other fiber optic fibers from their respective devices to the point where the energy will be further directed or redistributed by lenses or reflectors. Because of the typically high systemic cost and fragility of edge emitters, they may not be the first choice of an implementer of this technology. Although they can be used to practice this invention, they are not typically as robust as other NRED types and should be selected only after the other types have been fully considered.

A second and more useful type of laser diode is referred to as a VCSEL. The name is an acronym which stands for vertical cavity surface emitting laser. They would generally be considered more useful for implementing this type of cooking or curing oven because they can be mounted on circuit boards such that the energy is emitted perpendicular to the large planar surface of the circuit board. A substantially large number of them can be mounted on a single circuit board and because the energy is emitted perpendicular to the large plane of the circuit board, the board array's output can be aimed accordingly. With this type of configuration, the array mounted on the circuit board can literally be pointed toward the target directly or the energy can be lensed or reflected with skillfully engineered surfaces as needed. As of the date of this teaching, VCSELs cannot be manufactured in longer wavelengths above approximately 1275 nanometers. This may change in the future as new manufacturing techniques are developed which will then make them a reasonable choice for multi wavelength ovens that want to incorporate a longer wavelength for browning or other purposes, which may be above their current upper limit.

Another newer type of laser diode is called an SEDFB, which is an acronym that means surface emitting distributed feedback device, and is, in some respects, a better-adapted laser diode choice for implementing the presently described embodiments. These devices can be mounted on a printed circuit board in nearly any type of geometrical configuration, such that their irradiation is projected largely perpendicular to the large plane of the circuit board. Individual SEDFB devices can be very powerful, thus allowing the strategic distribution of the devices on a circuit board to project energy at a specified target with an engineered and desirable geometric spread required to evenly illuminate the target. They can be lensed, diffused, or creatively reflected to further define the photonic projection pattern. They also have the advantage, like VCSELs, of being easily configured in dense, mounting patterns, or X-by-Y arrays to project straight at the irradiation target. Their flexibility of configuration facilitates directly arranging the devices to adjust the intensity of energy reaching the various areas within the irradiation target field.

When employing any of the types of laser diodes for cooking, curing or any of the applications, great care must be taken to ensure that proper cooling is maintained for all NRED devices to prevent their overheating and consequent failure. While each of the types have a variety of preferred cooling methodologies, it is beyond the scope of this teaching to detail most of them. However, in one example form, a novel and useful methodology for cooling incorporated in the presently described embodiments is described in greater detail.

The second major category of NREDs is light emitting diodes or LEDs, or when outputting IR, RED's. Their power has grown continuously over the last forty plus years to the substantial output that they can produce as of this writing. The maximum output of an LED/RED depends upon its fundamental design and the wavelength of photonic energy it will produce. LEDs are available in U.V. (ultraviolet), visible, and infrared irradiant outputs. Currently single, surface mount LED devices are available in both visible light output and near infrared output, which will produce up to two optical watts of photonic output. Typically, if more power is desired from a nearly point source, the devices can be cluster-mounted and wire bonded on a ceramic heat spreading substrate or they can be manufactured as multiple device, integrated circuits, whereby multiple devices or multiple dies are produced on a single substrate for mounting simplicity.

According to the presently described embodiments, heating operates at the molecular level matching the photons of a particular wavelength to the resonance frequency of specific covalent bonds. Contrary to common belief, covalent bonds in molecules are not rigid like sticks or rods but are more like stiff springs that can be stretched and bent. As such, molecules experience a wide variety of vibrational motions whose characteristics are relative to their component atoms. Consequently, virtually all organic molecules will absorb infrared radiation that corresponds in energy to the appropriately matched vibrations.

Because of the quantum nature of light, it comes in packets of energy. Covalent bonds absorb energy from light in a quantum fashion, not linear fashion, as well. The formula is as follows:

$$E = hc / λ$$

where E is the energy, h is a number called Planck's constant, c is the speed of light and > is the length of the wavelength.

The presently described embodiments use light waves and the quantum phenomena of energy transfer from electromagnetic radiation to a molecule to bring it to an excited energy state as it absorbs the light photon in turn generating heat. Electromagnetic radiation, also known as light, is generated at specific frequencies in the near IR that correspond to the absorption harmonics that affect change in the energy state of a targeted molecule. By utilizing an overtone harmonic in the near-IR, versus the primary absorption frequency in the mid-IR, weaker absorption occurs at the covalent bond level of the molecule and therefore deeper penetration into an amalgamation of molecules occurs. The result is a usable rate of energy transfer and deeper penetration of heat into the target.

Unlike nature and broadband heating methods, in a semiconductor based, narrowband energy oven, specific wavelengths can be generated to effect heating on specific molecules while avoiding others. In nature, because water is a broadband absorber in all but some of the near-infrared wavelengths, all broadband heating methods tend to overly cause heating of foodstuffs or coatings containing water.

The mechanism of heat generation using narrowband infrared light is as follows: All matter above absolute zero vibrates. In molecules, the covalent bonds within the molecules resonate with certain vibration frequencies. Electromagnetic energy, also known as light, has a specific frequency at which its wavefronts occur. In the visible light spectrum these wavefront frequencies correspond with specific colors because the vibrational state of the material being illuminated is such that it absorbs the wave or reflects or scatters it away from the target material. The wave is absorbed when the frequency of the wave matches the vibrational frequency of the material being illuminated. The quantum packet of energy from that wave is then converted into a higher electron state in the molecule. The color is released when the electrons return to their natural state releasing the energy perceived as the color. Absorption of light within matter, regardless of the wavelength, is based on matching the quantum vibrational states of the material being illuminated.

What we perceive as heat is just wavelengths in the infrared wavelength range being absorbed. In organic material, the primary vibrational state typically corresponds with mid-infrared wavelengths. The ability of photons from near-infrared light to be absorbed by an organic molecule is much weaker in intensity as compared with wavelengths in or closer to mid-infrared light frequencies. This is due to the near-infrared wavelength being an overtone, or harmonic, to the primary mid-infrared frequency that matches the particular quantum state or vibrational level of the electrons in the covalent bonds in the organic molecule. As such, light generated in the near-infrared range provides a unique opportunity to match specific wavelengths of energy to specific covalent bonds to effect absorption at a rate that allows for deep penetration into an amalgamation of molecules while avoiding unwanted heating effects on other molecules such as water. Think of it as the overtone harmonics are smaller wavefronts than the desired vibrational frequency of the electrons in the covalent bonds in the molecule. Some of the overtone harmonics hit the vibrational state of the electrons just right and excite them to a higher state causing them to vibrate more, thus causing heat. The majority pass on through until they encounter a molecule where the vibrational state is just right, and the quantum packet of the wave is absorbed. It is an all or nothing proposition. Either the waves match up just right and the electrons absorb the packet of energy, or the light wave passes through until it hits the molecule vibrating in just the right sequence. This is unlike using the primary vibrational state where the vibrational match is near perfect and all energy is absorbed.

As an example, in the approximate 2.7 to 3.3 micron range the O—H covalent bond in molecules such as water, H2O, and the N—H covalent bonds achieve maximum stretching vibration from the quantum energy delivered at this frequency. As such, water, exposed to electromagnetic radiation of 3 microns absorbs and quickly converts all light energy at this wavelength into heat with almost zero penetration beyond the surface.

Near IR (versus mid IR) has many advantages in connection with the presently described embodiments. Near-infrared light generally refers to light in the 720 nm to ˜2,000 nm wavelength. Absorption of light regardless of the wavelength is based on the quantum vibrational states of the material being illuminated. However, the ability of near-infrared light to be absorbed by an organic molecule is much weaker in intensity as compared with wavelengths in or closer to mid-infrared light frequencies. This is due to the near-infrared wavelength being an overtone, or harmonic, to the primary mid-infrared frequency that matches the particular quantum state or vibrational level of the electrons in the molecule. As such, light generated in the near-infrared range provides a unique opportunity to match specific wavelengths of energy to covalent bonds to effect absorption at a rate that allows for deep penetration into an amalgamation of molecule such as food stuffs.

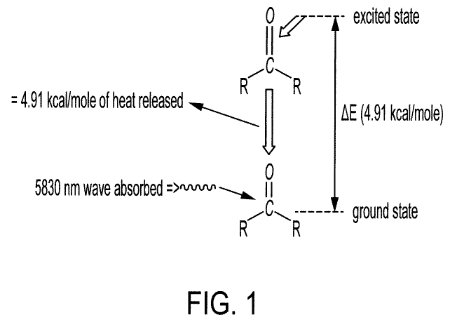

With reference to FIG. 1, a simple line drawing can be used to express the mechanism of how the molecule absorbs the energy and releases it as a particular wavelength imparts energy to bring a molecule to an excited state and then the molecule returns to a ground state as it releases energy in the form of heat. In this diagram, C represents Carbon, O represents Oxygen and R represents a continuation of the molecule. This particular covalent bond, a carbon oxygen double bond, has a high propensity to resonate with and absorb the quantum packet of energy at a wavelength of 5830 nanometers (which corresponds to a frequency of 5.15×1013 Hz). Using the above equation, the energy imparted at this wavelength is 4.91 kcal/mole.

The presently described embodiments, in at least one form, relate to a novel way to configure and improve, e.g., optimize, a systemically approached NRED oven. The NRED oven may take a variety of different forms for different applications, such as food processing, thawing, holding, heating or cooking, or certain industrial applications, some example forms of which are described herein. Many of these features of the presently described embodiments have been devised because they are advantageous and very desirable to achieve the objective of creating a fully functional NRED oven system. The unique configuration of all or nearly all of these later-to-be-described elements, will enable the construction of a fully functional NRED oven that is robust, flexible in applications, and has substantial functional life in real life cooking, heating, drying, thawing, and curing applications. Many of the features of the presently described embodiments, in at least one form, provide a configuration so that the system results in a robust and fully functional NRED oven, configured uniquely to fill a strong market need and prevent premature system or device failure. In this regard, a stack or assembly of components including, for example, an array of NREDs, to be described incorporates many of the features of the presently described embodiments to achieve a useful NRED oven.

The features, or combinations thereof, of the presently described embodiments results in an improved, e.g., optimized, system. These features will be described here and detailed further thereafter.

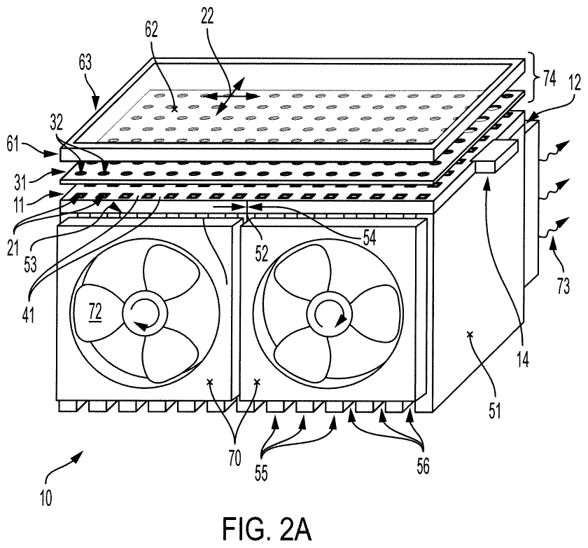

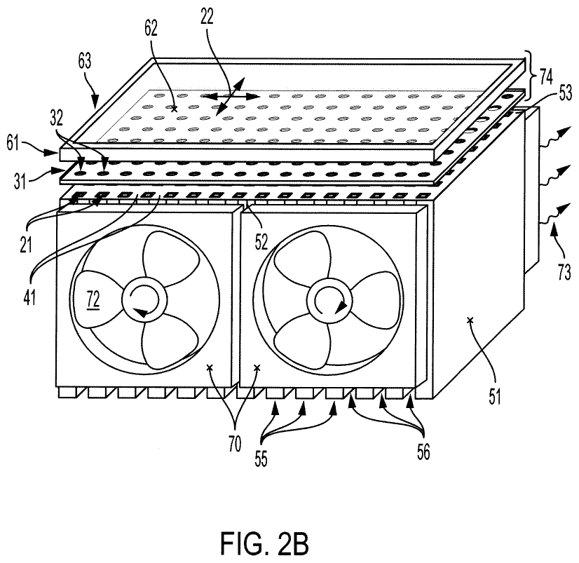

With reference to FIGS. 2 (a) and 2 (b), as one example feature, in at least one form, a device or assembly or stack 10, in at least one form, includes at least an NRED array board, or substrate, 11 made from, in at least one form, highly thermally conductive board substrate and often densely populated with NRED devices 21 arranged in an array. In at least one form of the array, at least one of the NREDs in the array produces narrowband photonic output between 720 and 1180 nanometers. In another example form, at least one NRED are incorporated which produce their narrowband output between 1360 and 1560 nanometers in order to be absorbed nearer the surface of a comestible target. With respect to the substrate, in at least one form, the substrate 11 formed of a thermally transmissive material, such as a material with an index of thermal conductivity of at least 160 W/mK.

As will be appreciated, however, the substrate or board may take a variety of different forms and, in at least one form, is incorporated in the noted stack or assembly of the presently described embodiments. The associated array of NRED devices are also a part of the stack or assembly.

As another example feature, in at least one form, an NRED array board 11 is densely packed with NRED devices arranged in at least one array and designed to produce greater than 25 watts per square inch of projected energy on all surfaces of the target plane, as shown at 22. However, in other forms, the board may be designed to produce other outputs such as, for example, 4 watts per square inch or 6 watts per square inch. The array board or boards may be incorporated in a system, e.g., an oven system, configured to produce one of at least 20 Watts/Square Inch, 40 Watts/Square Inch, 60 Watts/Square Inch, 100 Watts/Square Inch, 120 Watts/Square Inch, or 140 Watts/Square Inch.

As another example feature, in at least one form, an NRED oven using at least one stack or assembly or device 10 is designed to have a target plane to be irradiated of greater than 12 square inches, which dictates a minimum total power output of at least 300 Watts of optical irradiation at 25 watts per square inch. Of course, other results will be had at other power densities such as 4 watts per square inch (48 watts of optical radiation) or 6 watts per square inch (72 watts of optical power).

The metric of 12 square inches for a target plane is merely a useful example. Other measurements of the target plane, such as 40 square inches may also be used effectively by the presently described embodiments. Further, the target plane, in at least one form, is defined by contiguous area, such as 12 square inches or 40 square inches; however, the area does not necessarily need to be contiguous because of the ability to radiate in patterns using the narrowband technology of the presently described embodiments. Thus, according to the presently described embodiments, the target plane may be defined by, for example, 12 square inches in a checkerboard or other discontinuous pattern.

It should be appreciated that, in at least one form, the target plane is the plane in which the target (or, e.g., target item, item to be heated or cured, or food item or comestible) sits. In another example, in at least one form, the target plane is the top surface of the target, with the top being defined as the surface facing the NRED array, which will be impacted first and directly by the output from the NRED devices. For other applications, the target plane may further vary. For example, the target plane for a given application may be defined as halfway through the thickness of the target. Or, in another example, the target plane of the target may be defined as a plane through the average thickness of the target.

As another example feature, in at least one form, a micro-lens array 31 is implemented to improve, e.g., optimize, and strategically deliver the energy for each of the individual NRED devices on the array board 11 through the respective individual lenses 32, or alternatively, integrally lensed NRED devices 21. In at least one form, the micro-lens array 31 is a part of the stack or assembly.

As another example feature, in at least one form, a highly reflective overlay 41 of corner-cube sheeting is utilized with windows for the NREDs to protrude through and to allow the device's energy projection to pass without interference to the irradiation target. This overlay 41 also boosts systemic efficiency by reflecting the photons back to the target that have reflected off without imparting their energy into the target. In at least one form, the overlay 41 is a part of the stack or assembly.

As another example feature, in at least one form, a heatsink 51 is used whose top surface is adjacent the circuit board 11 and is at least as large as the circuit board 11. The heatsink 51, for some applications, has accommodations for air to be force-circulated through it or past its radiative surfaces 55, 56 for applications requiring correspondingly more cooling. It will be appreciated that the heatsink may take a variety of different configurations. However, in at least one form, the heatsink has a mass of at least ten (10) times the circuit board substrate. Further, in at least one form, the heatsink material has a thermal coefficient of conductivity of at least 205 W/mK. In at least one form, the at least one heatsink provides substantially increased surface area compared to a surface of the separate circuit board thereby providing much more heat absorption and dissipation and facilitating more surface area for radiant cooling to surrounding ambient air. In at least one form, the heatsink is intimately in contact with and is sized similarly to a bottom of the substrate. In at least one form, the heatsink provides the system with substantially increased surface area, for more heat absorption and dissipation and facilitating more surface area for radiant cooling to surrounding ambient air. In at least one form, the heatsink 51 is a part of the stack or assembly.

As another example feature, in at least one form, between the highly thermally conductive circuit board 11 and the heatsink 51 is a highly transmissive heat spreader grease 12 or other substance is used for good thermal coupling between the two and to help prevent non-thermal conduction areas or hot spots on the circuit board. Accordingly, the interface between the heatsink and the substrate is coated with thermal grease to increase a thermal conduction into the heatsink.

As another example feature, enlarged conductive circuit traces are formed on the circuit board on which each NRED device is mounted (e.g., soldered), the traces being enlarged to the maximum extent possible before shorting to neighboring traces, in order to spread the heat quickly away from the soldered base of each semiconductor NRED device. They can be enlarged so that they are, for example, within 0.015″ of shorting out with a neighboring trace. This measurement, of course, could vary depending on the implementation. For example, in at least one form according to the presently described embodiments, the trace could be within 0.050″ of a neighboring trace, e.g., within 0.050″ of shorting out with a neighboring trace. In at least one form, the traces are enlarged in thickness. It will be appreciated that both the thickness and width of the traces may be enlarged to enhance its heat spreading capability. In at least one form, the traces or the enlarged traces are a part of the stack or assembly.

As another example feature, in at least one form, referring only to FIG. 2b, an alternative structure for even more optimized NRED cooling utilizes the top of the heatsink as the circuit board surface. A diamond-like coating or aluminum nitride coating is applied directly on top of the heatsink surface as a highly thermally conductive but electrically insulative layer. In at least one form, the coating is a part of the stack or assembly.

With this alternative arrangement, shown in FIG. 2b, in at least one form, the circuit traces are bonded directly on top of the diamond-like coating or aluminum nitride coating. Standard circuit board insulation coating is applied above the circuit traces. The NRED devices are soldered directly to the circuit traces.

As another example feature, in at least one form, referring back to FIGS. 2 (a) and 2 (b), cooling fans 70 are mounted to force air through or past the fins or radiative surfaces 55, 56 of the heatsink 51. As such, the system is provided with at least one fan, and the at least one fan is positioned to generate air flow to remove heat from any of the at least one array of NREDs, the circuit board substrate, the corresponding lenses, and the air space. In at least one form, the fans are a part of the stack or assembly.

As another example feature, for multiple array NRED oven designs, the heatsinks 51 are similar in size, but no smaller than its corresponding array circuit board 11, and its physical configuration facilitates positioning the arrays 15 edge-to-edge at 54 such that the array/heatsink assemblies shown edge-to-edge at 52 locate the NRED devices with a consistent spacing of NRED devices from adjacent arrays, thus forming an enlarged continuous array composed of multiple circuit board arrays that are nested side by side. The design facilitates that the NRED radiant output provides a homogeneous irradiation of a target plane.

Alternatively, or in conjunction with fan air cooling across the heatsink, for more demanding applications, water is routed through channels in the heatsink 51-which is recirculated through a heat exchanger or reservoir for much higher cooling capacity.

As another example feature, in at least one form, a protective overlay or plate 61 is used, topping the whole assembly. In at least one form, the protective plate is formed of at least one of glass, plastic, or transmissive ceramic material and is positioned between the target item or comestible and the at least one array of NREDs and, if applicable, one of the corresponding lenses or the engineered reflectors. In one example, the protective plate is made of borosilicate glass or heat tolerant plastic with an anti-reflective coating on it. The protective overlay 61, in at least one form, is highly transmissive at the wavelengths employed in the oven. If the glass is not coated with an anti-reflective coating, the protective plate may not have more transmission than about 85% (or, in some cases approximately 82%), but if coated on both sides, it may be in excess of 98% transmissive. This helps the overall system to be much more energy efficient, because the energy that is being produced by the NRED devices can be used much more efficiently and not wasted as extra heat. In at least one form, a feature of the protective plate 61 is that it is generally flat and configured to be easily cleaned and/or scrubbed—as will be desired in many implementations. In at least one form, the protective layer 61 is a part of the stack or assembly.

As another example feature, in at least one form, around the perimeter of the protective overlay plate 61, in at least one form, is an elastomer or a structure 63 to seal it to the side walls of the oven, to prevent contaminants from reaching the NRED arrays or other control or power circuitry such as traces, lenses, power supplies or other sensitive components.

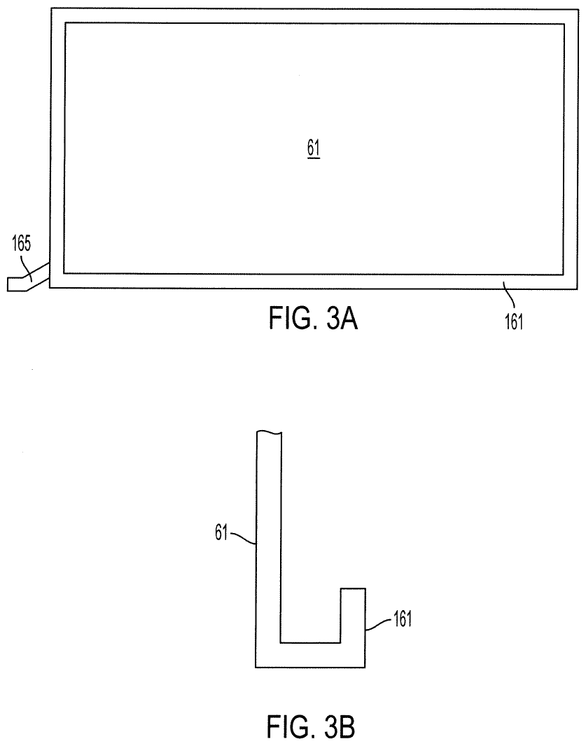

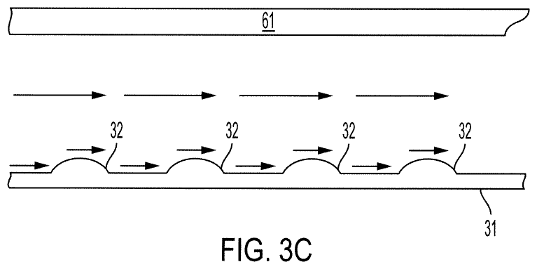

As another example feature, in at least one form, with reference to FIG. 3 (a) and FIG. 3 (b), around the perimeter of the protective overlay plate 61, in at least one form, is a channel or gutter 161 to collect and, in some forms, remove excess liquid from the chamber or oven. This channel or gutter 161 may be integral with the protective overlay, as shown in FIG. 3 (b), or be formed with an attached border frame or piece. Further, as shown, a drain 165, or other drain arrangement, is provided to the protective plate 61 to carry away liquid, liquid contaminants, or the like.

As another example feature, in at least one form, an air circulation space 74 is provided between the NRED devices (and/or the circuit board substrate and/or the lenses and/or engineered reflectors) and the protective overlay to prevent a heat buildup in that space and, for many applications, forced ambient cooling air is directed through that space. In at least one form, air circulated through the air apace 74 cools the lenses that may be part of the system as individual lenses for each emitter or integrated into a lens array. Also, in one such example configuration shown in FIG. 3 (c), the lenses provide a physical elevation of the surface in the air space 74 that narrows the air path between the lens array 31 and protective plate 61, for example, thus increasing the velocity of the air flow. This enhances the heat transfer characteristics of the air space. Of course, a similar benefit is achieved in configurations where each emitter has its own lens, as the lens in those configurations likewise narrows the path between the circuit board or heatsink, in some embodiments, to increase velocity of air flow.

As thus far described, it should be appreciated that the stack or assembly 10 may take a variety of forms. However, in at least one form, each stack comprises at least one array of NREDs, at least one substrate, at least one protective plate and at least one fan. In at least one form, each stack comprises at least one array of NREDs, at least one substrate, at least one protective plate, at least one heatsink and at least one fan. In at least one form, each stack comprises at least one array of NREDs, at least one heatsink, at least one protective plate and at least one fan.

It should also be appreciated that various structures are provided to the NRED Oven and the stacks that, in at least one form, are configured to hold the at least one array of NREDs and the substrate (or heatsink) upon which the at least one array of NREDs is mounted in a predetermined position in the NRED oven and to provide a platform to support the target or comestible item for irradiation. In at least one form, the structures are configured to hold the at least one array of NREDs, the substrate upon which the at least one array of NREDs is mounted, and the heatsink in a predetermined position in the system and to provide a platform to support the target or comestible item for irradiation. As will be described, these structures may take various forms, depending on the application. For example, for an oven with an enclosed heating chamber, the structure may be the walls of the chamber. For a tunnel, the structure may be the support mechanism for the stacks lining the tunnel. For a holding configuration, the structure may be the support table or stand (and associated legs) that cover the irradiation or heating area or zone. The structures contemplated herein may also comprise appropriate mechanisms to maintain the components of the stack in a fixed relationship.

As another example feature, the side walls of the oven are arranged at the correct angular orientation to facilitate being coated with a thin, corner-cube reflection sheet or approximate corner-cube sheet with an easy, wipe-clean outer surface. This example of the corner cube reflectors addresses irradiation that reflects off the target and is redirected back to the target by the corner cube reflectors. In other forms, the walls of the oven or chamber are configured with more conventional reflectors (e.g., polished chrome, mirrors or copper) to address stray radiation in the chamber from any source that should be redirected to the target.

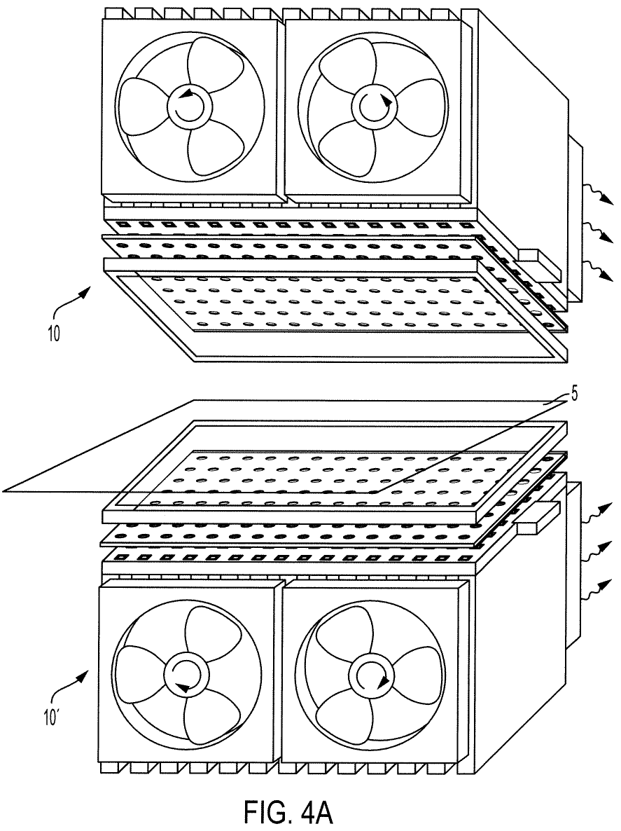

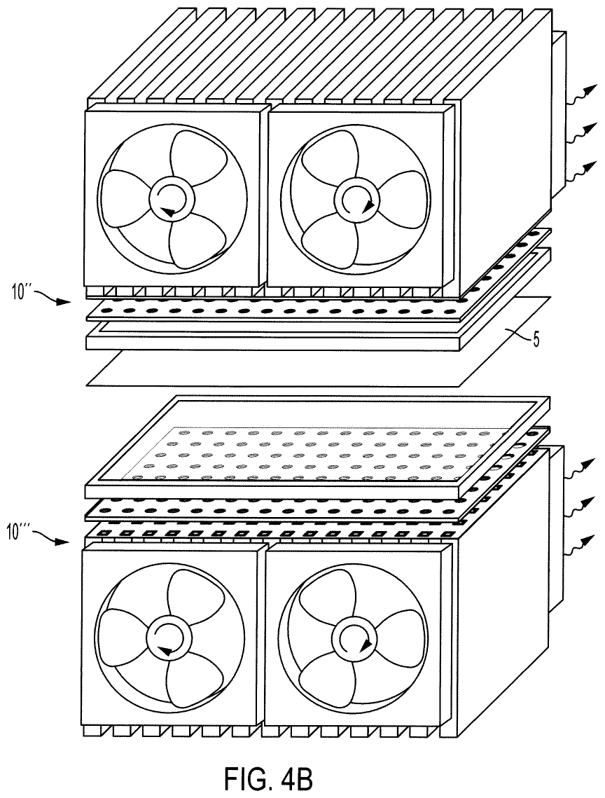

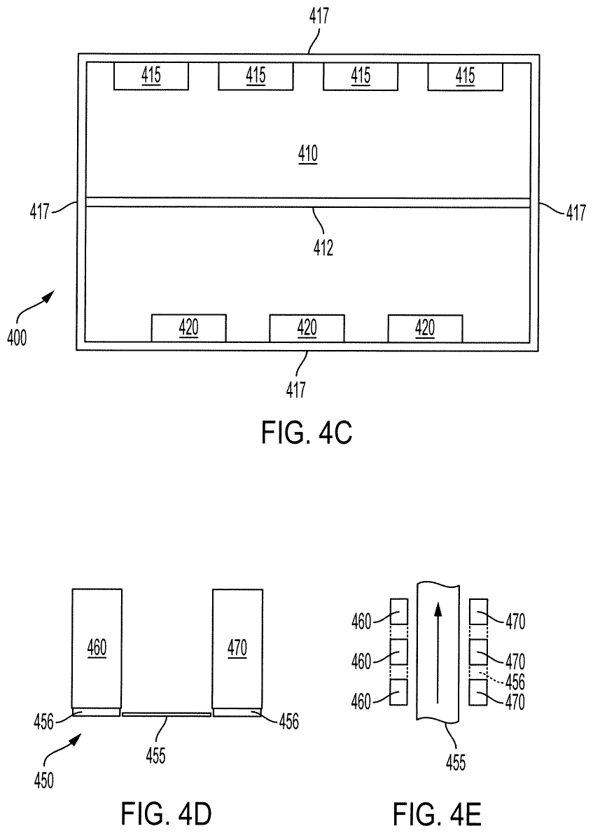

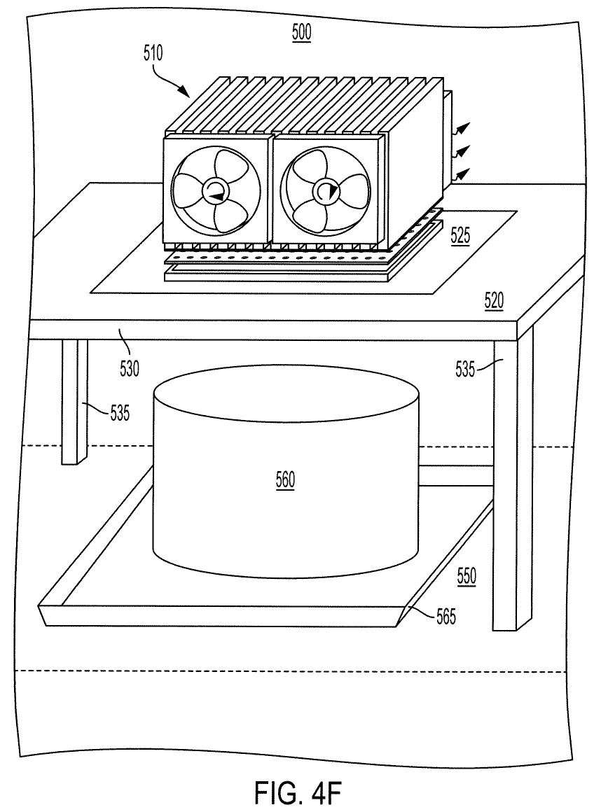

As another example feature, in at least one form, with reference to FIGS. 4 (a) and 4 (b), for a more capable oven, NRED devices, such as devices 10, 10′, having emitters mounted on a board, or devices 10″ and 10″, having emitters mounted on a heatsink, having similar features, alone or in combination, as described here, are arranged on opposite sides of a target plane 5, facing the target irradiation space from approximately the other direction, such that a target item or comestible may be irradiated from both opposite sides. As will be appreciated, the devices 10 and 10′ could be aligned and rotated slightly as in FIG. 4 (a), on opposite sides of the target plane 5. Or, as in FIG. 4 (b), the devices 10″ and 10″ could be aligned with one another in a substantially parallel fashion as shown on opposite sides of a target plane 5. These opposed devices in both FIG. 4 (a) and FIG. 4 (b) could also be offset, partially or completely, depending on the actual implementation.

With reference now to FIG. 4 (c), in at least one form, an implementation of the NRED devices is illustrated. In this regard, a representative depiction of an oven 400 is shown. The oven 400 includes a heating chamber 410 with a shelf 412 to support a food item, comestible or other item being heated. As shown, a plurality of NRED devices 415 are positioned at a top of the oven and a plurality of NRED devices 420 are positioned in opposed but partially offset locations on the other side of the shelf 412, or bottom of the oven. The number of NRED devices or arrays of NREDs may vary in any given application. For example, the at least one array of NREDs may comprise one of two arrays of NREDs, four arrays of NREDs, six arrays of NREDs or eight arrays of NREDs, or any other suitable number. Of course, the food item, comestible other item is not shown on the shelf 412 but would define a target plane. Also shown are walls 417 defining the heating chamber and providing structure to hold the at least one array of NREDs and the substrate (or heatsink) upon which the at least one array of NREDs is mounted in a predetermined position in the NRED oven and to provide a platform to support the target or comestible item for irradiation.

Referring to FIG. 4 (d), another example of an implementation of NRED devices is illustrated. In this example, a heating tunnel with a conveyor or other transport mechanism 455 is defined by NRED devices 460 and NRED devices 470. Although a variety of configurations are possible, as shown, the NRED devices 460 and the NRED devices 470 are positioned in an opposed manner. As shown in FIG. 4 (e), the NRED devices 460 are aligned is such opposed manner with the NRED devices 470. Also shown are support structures 456 to hold the at least one array of NREDs and the substrate (or heatsink) upon which the at least one array of NREDs is mounted in a predetermined position in the NRED oven and to provide a platform to support the target or comestible item for irradiation.

Referring to FIG. 4 (f), another example implementation 500 of an NRED device or stack 510 (as described) is shown. In this regard, a strong need exists for both private consumers as well as restaurants to hold food for a time after it is prepared and before it is served, so that it is at the correct temperature when served. It is very desirable, but a technology has not been available, to hold food for a period of time without significantly drying out the food and reducing the tastiness of the food. Sometimes it is desirable to hold the food at temperature for a shorter time, for example, 15-30 minutes, but often, especially in some restaurant settings, holding it for greater than 30 minutes, e.g., 1 to 3 hours, may be needed. An example of a desired long-term holding application is for fried or grilled chicken, which the restaurant operators would like to be able to hold for greater than 30 minutes, e.g., at least 2 hours, without any deleterious effect to the chicken's taste.

To service this need, another way that the presently described embodiments, e.g., another form of an NRED oven, can be configured is to use the equipment stack 510 as outlined herein, but it would be mounted such that the irradiation is sourced from above. Usually, it would only be irradiating from above for this application, but it could be from both above and below. The more practical structure, would be constructed to hold the NRED stack 510 above the comestible so that the irradiation can be directed down from above to irradiate the food product directly. This configuration would usually be mounted so that the NRED array(s) would be largely horizontal, but their narrowband infrared energy would be directed generally downward, which is perpendicular to the large plane of the NRED array mounting surface.

FIG. 4 (f) shows the general configuration that would be used for this type of application. As shown, the implementation 500 includes the stack 510 supported by a stand 520. The stand 520 includes a platform or table 530 with legs 535. The stand 520 is also provided with a port or transparent window 525 through which the stack 510 can emit irradiation directed at the heating or irradiation area or zone 550. The port or window 525 may take a variety of forms to accommodate suitable or desired operation of the stack 510. With the implementation 500, a food item 50 that is plated, positioned, or on a platter 565 can be warmed or kept warm by being placed in the irradiation zone 550 until it is time to serve it. That is, in at least one form, the system uses a stack 510 that comprises the at least one array, the substrate, the protective plate and the at least one fan, and the stack is mounted above a heating zone. The stand or structure provides a space below for the comestible, and irradiation is aimed generally downward such that the irradiation is absorbed by the comestible directly so as to not pass through any plating item on which the comestible is placed before hitting the comestible.

Heating from below in this holding food at temperature type of application would not take full advantage of the heating benefits of the narrowband technology. From below, it would heat the plate, platter or whatever it was sitting and the hot plate or platter would re-radiate at much longer wavelength into the comestible item, thus drying it out unnecessarily. The exception to this general rule would occur if the plate or platter is largely transparent at the narrowband wavelength that is being employed. In this case the plate or platter would need to be glass or other highly transparent at this wavelength like the right plastic. It could be paper or other transparent material. These transparent materials may not be preferred in a restaurant situation or even in a home environment, since most serving plates are not transparent at these preferred narrowband wavelengths. Thus, the better solution if this technology is to be used for holding food at the ready for selling or serving with minimal drying, may be to irradiate from above.

The amount of energy to keep a comestible at a serving temperature is less and sometimes could be dramatically less than the amount needed for the actual heating-up or cooking function. It depends on the actual temperature that is to be maintained and the size and/or weight of the comestible item(s) to be held at a temperature. It is assumed that food would often be kept at a temperature range between 135 to 165 degrees prior to serving. It also may be desirable to employ wider angled NRED devices so they can be spread out more on their respective circuit boards and so they may gently irradiate the food from a wider range of angles than might be used for normal cooking operations. As a guideline, it is generally desirable to have at least 4.0 watts per square inch available for this irradiation. The perfect amount will vary, depending on environmental conditions and preferences. To save money on the bill or material cost and if the NRED irradiation is to be done from above and will be used largely or exclusively for holding at temperature prior to serving and after the actual cooking, it is possible to build the upper stack without the protection plate. This is less than ideal because it still is likely to get contaminated from accidents, spills, and mishandling, but it may lower the cost enough to justify this less desirable configuration of the stack. Generally, it is desirable to build a holding system for ease of cleaning and to maintain sanitary conditions, hence dictating a protective sheet configuration. The narrowband irradiation energy should be supplied to at least 12 square inches of target plane area for practical application and that target plane should normally be defined by contiguous square inches so there are not gaps in the coverage causing such things as cold and hot spots or uneven heating. There may be some applications where something more like a checkerboard pattern may be dictated. Often it is desirable to have 40, 60 or even many more square inches, so that plated food can be kept in the exact configuration in which it will be served. Some applications, in order to have the needed space under the irradiation footprint might need to be hundreds of square inches. One can assume that much larger contiguous or non-contiguous areas of coverage with the 4.0 watts per square inch could be useful for large restaurant or banquet kitchen preparation areas or banquet holding carts.

It should be appreciated that the various embodiments of the NRED oven, those shown and others, as well as individual stacks, are provided with control and processing capability. The variations of such control and processing depends on a variety of factors including the application of the presently described embodiments. In at least one form, a control system is operatively connected to at least one DC power supply, the at least one DC power supply being operatively connected to the at least one array of NREDs and capable of continuously controlling the amperes of electrical current being supplied thereto or a power supply which is used in conjunction with at least one electrical component which limits the current to the at least one array of NREDs. In at least one form, the system is configured with more than one NRED array and each NRED array can be controlled separately and may be aimed at a target area zone that is one of the same area, partially overlapping areas, and completely different areas. Further, in some examples, different power levels can be delivered to different zones from either whole NRED arrays or sub-sections of NRED arrays to achieve desired results in each zone. Also, in some examples, completely different sequential digital irradiation programs can be delivered from each NRED array.

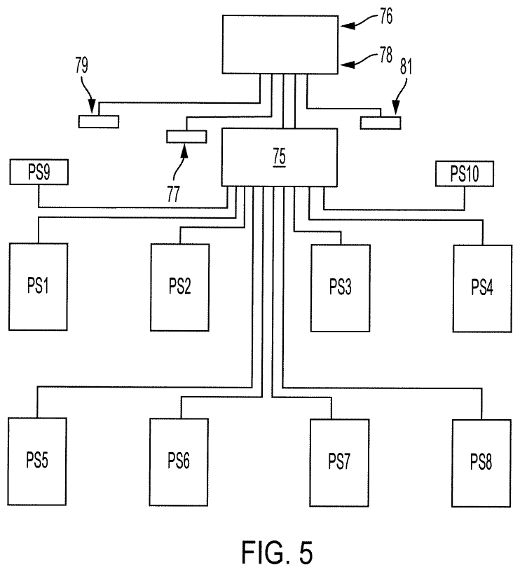

As an example, with reference to FIG. 5, a system is provided with an example of appropriate control and processing capability. In one form, the system includes a power controller 76 and a processor or controller 75 to control, among other functions and hardware, the narrowband arrays that are strategically implemented in the system, e.g., in the irradiation area, to radiate the target substrate with narrowband energy according to various recipes. The system is also provided with a sensor control to control sensors 79 in the system, including the IR sensors and cameras (and spectral sensor). Of course, a memory unit 330, or several memory units, are included in the system. In this regard, the presently described embodiments, in at least one example, include suitable software program(s) (e.g., instructions and/or code which are stored on the at least one memory 160) which, when executed by at least one processor, cause the processor and/or associated elements of the system to implement the method(s) according to the presently described embodiments.

Also, it will be appreciated that the structures and procedures shown above are only a representative example of embodiments that can be used to facilitate embodiments described above. In this regard, the various embodiments described in the examples above may be implemented using any suitable circuitry, hardware, and/or software modules that interact to provide particular results. One of skill in the computing arts can readily implement such described functionality, either at a modular level or as a whole, using knowledge generally known in the art. For example, the methods described herein may be used to create computer-readable instructions/code for execution by a processor. Such instructions may be stored on a non-transitory computer-readable medium and transferred to, for example, the processor for execution as is known in the art.

In this regard, it should be appreciated that the processors and controllers and the sensor controllers are merely examples-they may take a variety of forms. For example, the above-described methods and/or techniques can be implemented on a system such as an oven, heating tunnel, or similar device using well-known computer processors, memory units, storage devices, computer software, and other components. As shown in the example representations of such a system, the units include at least one processor, which controls the overall operation of the units by executing computer program instructions which define such operation and a sensor controller. The computer program instructions may be stored in at least one storage device or memory (e.g., a magnetic disk, a solid state disc, or any other suitable non-transitory computer readable medium or memory device) and loaded into another memory (not shown) (e.g., a magnetic disk or any other suitable non-transitory computer readable medium or memory device), or another segment of memory, when execution of the computer program instructions is desired. Thus, the steps of the methods described herein may be defined by the computer program instructions stored in the memory and controlled by the processors (and/or the controllers) executing the computer program instructions.

As an example feature, in at least one form, a central power control board 76 operatively commands the multiple power supplies PS1-PS10 as needed to drive the respectively connected arrays or strings in order to deliver the sequential digital irradiation recipe. In this regard, as another example feature, the NRED array boards 11 are comprised of multiple strings of NRED devices, each string being potentially separately controllable if dictated by the application, whether or not a central power board is provided. Also, as another example feature, each power supply PS is operatively connected to the arrays and strings of NREDs through electrical edge connector 14 and capable of producing a commanded DC electrical current and controlling that current at a constant or variable level as needed according to a sequential digital irradiation recipe. The specific application needs drive decisions as to how many strings would be individually controlled to serve the positional delivery of irradiation required for the application.

As another example feature, in at least one form, a supervisory control system 75 loads and then holds a sequential digital irradiation recipe to be sent to the central power control board 76 to be executed for the cooking or curing task at hand, and sequential digital irradiation recipe could come from one of two sources.

As another example feature, in at least one form, one source for the recipe is received directly from the encoded information from a cookpack which stores and facilitates reading of the exact sequential digital irradiation recipe.

An alternate source of the sequential digital irradiation recipe is composed and executed by the control system 75 based on the joules of energy and irradiation times that should be delivered to each section of the target item or mix of target items.

As another example feature, in at least one form, the control system 75 further commands the central power control board 76 which, in turn, executes the sequential digital irradiation recipe by supplying the requisite DC electrical current to the respective NRED arrays 15 or individual strings of devices 21.

As another example feature, in at least one form, the supervisory control system 75 is operatively connected to a digital code reader 77 which would read the specifications of the sequential digital irradiation recipe from the cookpack or target item.

As another example feature, in at least one form, the supervisory control system 75 interprets and calculates the required joules of energy in the context of the installed power in this specific model and design of oven and translates what control signals and timing needs to be delivered to the central control power board 76 for the installed power and equipping of that particular oven, to enable correct cooking or curing according to the sequential digital irradiation recipe.

As another example feature, in at least one form, the supervisory control system 75 is operatively connected to a user interface panel 81 from which stored user preferences and user communications would occur.

As another example feature, in at least one form, the supervisory control system is also operatively connected to sensors 79 which, when the oven is used for cooking and cookpacks, such as AltaTherm cookpacks, are used, verify that the cookpack is in the exact unique location in the oven for correct cooking. These sensors may include a color or infrared camera 78.

As another example feature, in at least one form, once the user puts the cookpack into the correct location, the supervisory control system 75 asks, through the touchscreen or voice powered user interface 81, whether it should proceed with cooking the cookpack and asks for any preferences that needed to be determined before cooking commenced.

As another example feature, in at least one form, if being used for cooking using cookpacks such as AltaTherm cookpacks, the control system 75 also verifies that the cookpack is within the safe date limitations and, if connected to the internet, verifies if any updated sequential digital irradiation recipes are available and/or if there are any product recalls.

As another example feature, in at least one form, if being used for cooking and upon attaining all of the appropriate information and permission through the user interface, to proceed with cooking, the supervisory control system 75 will commence the cooking operation accordingly through its operatively connected sub-system components.

More particularly, with reference back to FIG. 2 (a), according to the presently described embodiments, in at least one form, a device, stack or assembly 10 comprises narrowband radiant emitting semiconductor devices or (NREDs) operatively mounted and soldered to a highly conductive metal circuit board 11. The NREDs 21 can be mounted in a geometric pattern with respect to one another which could be a rectangular matrix, a circular orientation, or a geometric configuration that best serves both the irradiation pattern and the electrical hookup of the end application. For the most powerful oven applications and to effect the curing, heating, drying, or cooking at maximum speed, the devices can and should be operatively arranged so they are very densely packed, with minimum space between them. Consideration should be given to the far field irradiation pattern that is projected by the arrangement of devices on the board. The energy output shapes of the NRED devices are typically either rectangular, round, or oval. The far-field overlap of the collection of devices of the array should be arranged to produce the desired irradiation pattern intensity or to produce a homogeneous intensity level in the far-field or target plane. Target plane, in at least one form, refers to the plane at which the operative irradiation will be expected to impact a target item. That is, in at least one form, a geometric plane in which the targeted item or comestible will be placed for irradiation is referred to as the target plane.

The output of each independent NRED device 21 exhibits a particular type of dispersion pattern. With laser diodes, there will be a major and minor axis, at 90 degrees to one another, but each axis generally exhibits a gaussian shaped intensity curve. The devices should be arranged so that the composite or combined output of all the individual devices yields the irradiation pattern that is right for the particular oven design or application. If the system designer is trying to achieve a perfectly homogeneous pattern at the target plane, it should be recognized that it will probably never be perfectly uniform for several reason including the devices vary in their actual photonic output, sometimes slightly but sometimes significantly, depending on the precision of the manufacturing process; the composite output pattern is inherently a lumpy combination of many devices, each of which has a gaussian output curve of some shape, so the composite cannot be completely smooth but benefits from the combination of the many photonic output beams; and, the lenses in front of each device, whether built-in or added, are mounted with a slight variation in positioning relative to the actual semiconductor die positioning. In at least one form, the lenses 32 may be provided to the system as part of a micro-lens array 31. Of course, other alternatives for lens configurations, including individual lenses provided for each NRED, may be implemented.

There are some applications which may call for a more customized energy distribution at the far-field food or target plane and the pattern should be adjusted accordingly by way of the arrangement of the individual devices 21 in relation to one another or by skillful use of lensing or engineered reflectors, such as micro-lens array 31.

NRED devices, whether they are laser diodes or LED/RED devices, typically have a voltage drop of between 1.3 and 3.0 volts. High powered NRED devices may require ten, fifteen, twenty, or more DC electrical amps each to drive them to their full power output. It is anticipated in the future that NRED devices 21 could be available which require substantially more current draw than that and will be able to produce more output photonic energy. The current draw for a given optical output is substantially modulated downwardly by efficient devices. NRED devices 21 can be selected from off the shelf distribution which may have optical output efficiencies in excess of 45%. Such devices can be further improved with sufficient formulaic tweaking, engineering, index-matching coatings, and manufacturing process optimizations which could theoretically enable future devices to achieve nearly 70% wall plug efficiency for near-IR devices. When wall plug efficiency is referenced for example, for ten watts of wall plug input, a 40% efficient device would produce four watts of optical energy output at its designed output wavelength range. As a result, for 50% efficient devices, 50% of the energy is produced as optical output and the balance 50% is produced as heat. That heat has to be dealt with very purposefully and should be dealt with systemically. Properly designing the devices themselves is important but just as importantly, the entire systemic electrical, mounting, and cooling infrastructure comprise an important aspect of the system. The cooling arrangements must be very carefully and purposefully engineered and configured to comprise a robust NRED oven. The presently described embodiments teach the whole range of novel interconnected infrastructure configuration to build a reliable, high powered NRED oven system.

A well-functioning NRED oven may need thousands of watts of optical energy to perform with its full effectiveness. There are no rules as to how much output power an NRED oven may require. Assays have shown though that there are certain minimums required for effective functionality. There are also recommended amounts of photonic energy or joules of energy that have been shown to be effective for various types of cooking. For simply holding food at a slightly elevated, ready-to-eat temperature, it may only require, for example, five watts per square inch of optical power, depending on the exact application and comestible type being held at temperature and assuming that the comestible was not in a highly convective environment. For actual cooking applications, it is desirable to have powers in excess of fifteen to twenty watts per square inch of total optical output energy. The total energy could be split by being projected from both top and bottom or side to side.

Effective NRED ovens will typically have, for example, more than sixty watts per square inch of total optical power projected, when measured at the target plane, which photonic energy must be highly controllable and throttleable to execute the sequential digital irradiation cooking recipe. NRED ovens with powers in excess of 130 watts per square inch can be built and would put them in the highest performance categories, able to cook or cure things at a much more rapid rate. Assays have shown it is not recommended to build NRED ovens for cooking which have less than 25 watts per square inch total projected onto the target plane. Less power will generally result in slower cooking time; however, where less power is desired, for example, where the target plane is irradiated at 4 or 6 watts per square inch, the user may be willing to tolerate slower cook times. In some cases, the total power projection can be split, so that, for example, half or a portion of it comes from above the target item and half or a portion of it from below the target item. It could come from two different sides which are approximately opposite each other. Extra power is often necessary and very desirable when cooking large or thick comestibles or foods that start off frozen, or when a substantially faster cooking time is desired.

When building an NRED oven, the geometric size of the comestible or target item must be considered as well. Cooking a small item such as a muffin may require substantial optical power per square inch, but it might only require, for example, ten or twelve square inches of far-field radiant target area. If, for example, a 9×14 inch casserole is to be cooked, it would dictate greater than 126 square inches of optical irradiation area. That calculates to 126 square inches, which at sixty watts per square inch of far-field irradiation, would require 15,000 input watts with 50% efficient NREDs. An NRED designer would have to recognize that the DC power supplies are not 100% efficient either. So recognizing that well designed power supplies could be, for example, 92% efficient, it would require additional input power. Excellent power supplies can be designed that function at greater than 97% when the circuit is optimized and the power factor is corrected for the load.

The design of the NRED array board and the power supply must be considered simultaneously. For individual NRED devices which require, for example, fifteen or twenty amps, it is unreasonable to have significant numbers of them in parallel electrically. For example, to have ten, twenty-amp devices, each dropping two volts in parallel, would require a 200-amp power supply at two volts. That is not a very practical or economical power supply. It would dictate very large wires and circuit traces and uncommonly available and expensive connectors. It makes far more sense to have those 10, two-volt devices in series so the required power supply can provide twenty amps at 20 volts. So, in order to keep the power supplies of a reasonable size and cost, it is highly desirable to have series strings of NREDs to run at the most desirable voltages to be easily supplied by available and economical power supplies.

The careful arrangement of the device string lengths and how many strings may be wired in parallel with one another is important to determining the best sized power supplies. Arranging for the right combination of voltage and current capacity makes a critical difference in the cost of the power supplies. But another factor is very related to overall systemic cost as well. The determination as to how many arrays of NRED devices will be driven in either series or in parallel by each individual power supply. The novice might choose to have, for example, two arrays driven by each power supply in an oven that has a total of eight arrays installed, which would then require a total of four power supplies to drive the arrays. This would facilitate a maximum control of four zones unless additional circuitry is added to modulate how much current goes to each array. Experience has shown that it is often much more economical for high powered ovens to use eight dedicated smaller power supplies rather than four shared larger ones which also provides an easy way of controlling each array or zone separately. This approach seems to yield a lower bill of materials cost overall, but also simplifies the overall electrical complexity. It is possible also to extend this concept further to subdivide arrays into sections, each of which can be operatively driven by a dedicated power supply for smaller zones without more complications of zone sub-controllers or other wiring complexities.

According to the presently described embodiments, the power supplies should be, in at least one form, current controlling power supplies to facilitate turning the irradiation output level up and down, as may be required by a given application or sequential digital irradiation recipe. If the power supply cannot control and limit the supplied current, other means must be incorporated, like current controlling resistors which must be carefully balanced to match the dynamic impedance of the array. LEDs and laser diodes will take whatever current is available in the circuit and burn themselves out if more current is available beyond their ratings or duty cycle tolerance. LED's can be turned down to whatever current level is needed for the particular application and energy delivery intensity. Laser diodes usually have a current level “sweet-spot” where their photonic efficiency is maximized. Often the output efficiency rises until the optimal current is reached and then is flat for a while as more current is applied until, at some current level, the efficiency begins to go down significantly until the maximum current is reached. If laser diodes are run below their most efficient current level, a big price must be paid in output efficiency and in some cases can cause device failure. Therefore, it is better to pulse modulate the laser diodes at the ideal current for lower powered portions of the irradiation programs. This allows the laser diode's net energy output over a period of time to be at any chosen level, but keeps the devices functioning at their peak output efficiency. It should also be appreciated that any form of an NRED or NRED array may be run in a pulsed or continuous mode, depending on the implementation according to the presently described embodiments.

The DC power supply can alternatively be a battery which is inherently a DC source, but an electrical means must be used to control the current to a safe amount that reaches the NRED device strings. Incorporating a battery source could be dictated what there is a need for portability, for example. Such a battery could be recharged from an alternating current or AC source, even with a wall wart type of charger. Or, it would be useful to recharge it from a vehicle which has either AC or DC power available. A properly sized solar panel or solar panel arrangement would also be a practical way of recharging the battery power if not near other sources.

As mentioned above, because NREDs inherently produce a substantial amount of heat along with the optical photonic energy they produce, it is important to keep them at a safe operating temperature to not damage the devices. When the devices are operatively mounted in a relatively high-density or very high density configuration, special accommodations must be made to keep the devices cool enough to not burn themselves out. In general, and with all types of NREDs, the cooler they are kept, the more their performance and life can be pushed to a high level of functionality. To attain the kinds of higher-powered output levels per square inch that were mentioned above, the current state of the art devices must be pushed to a pretty high level of functionality. Another advantage, however, is that the devices actually produce photonic output more efficiently if they are kept cooler. All NREDs will put out a different wavelength as they get warmer and will run less efficiently as the devices get hotter. This can change cooking or curing results, and cause a deviation in consistency of cooking or curing, if there is a significant change in temperature which drives a change in the output wavelength. It also can render the digital cooking program incorrect if a substantial enough change occurs in the NRED operating temperatures. If cooking or curing identical items repeatedly, it is possible to get different results if the temperature of the devices is not kept within a specified tolerance range. But, if the systemic cooling means is effective, slightly smaller power supplies can be used because the NREDs will be running cooler.

An important aspect of this invention involves creating a series of novel and interrelated deploying techniques throughout the system to make it more practicable. For example, an aluminum, copper, or other good thermal conducting material can be used as the material for the circuit board 11 on which to mount the NREDs. It is important that the circuit board substrate have a high thermal conductivity to conduct the maximum amount of heat away from the NRED devices 21. It is important to note that one should seek for high thermal conductivity to provide an important aspect of cooling and should not be confused with high thermal tolerance, wherein the devices and board are capable of withstanding high heat without damage. The goal is to conduct the heat away from the NRED devices 21 as rapidly as possible, to actually keep them cooler and not just to tolerate a high heat buildup. As was mentioned above, several deleterious results will result as the devices are allowed to get hotter. While a metallic or ceramic circuit board substrate may have a high thermal conductivity, it has other limitations which can be overcome with the following alternative configuration, further augmenting the systemic cooling.

A dielectric or non-conductive material is normally deployed between the circuit board substrate and the circuit board traces when a conductive circuit board substrate is used. Most of these dielectric or insulator materials are very poor thermal conductors. They may have on the order of one to three watts/meter-kelvin of thermal conductivity, but that is actually very poor and less than roughly one or two percent of the thermal conductivity of the circuit board itself (or even of the heatsink). Traditionally, one would say that because the dielectric insulator is very thin, and therefore is not terribly important; but when rapid heat removal and dissipation is of the utmost importance, this thin layer of poor thermal conductivity becomes a barrier to optimal performance. It functions more detrimentally as an insulator between two good thermal conductors, the circuit board and the trace metal. It causes heat to build up in the NRED devices because it can't be quickly pulled away and spread or dissipated beyond the circuit traces.

Much searching and experimentation was expended in locating and qualifying a dielectric that was truly highly thermally conductive. Many different materials were investigated for this purpose but with poor results. Special hybrid materials were investigated but still with very disappointing performance when compared to the thermal properties of the circuit board. It was recognized that diamond has fantastic thermal conductivity and is also an excellent dielectric or insulator. But diamond, in most forms, is expensive and difficult to apply. After much searching and coercing, a source was ultimately developed that could apply a diamond-like material to the top of highly thermally conductive circuit boards. The next challenge was the revelation that conductive circuit board trace material could not be easily applied to the slippery and nonporous diamond surface. With enough searching and careful specification, a commercial supplier was found who could apply a copper-based circuit trace material to the diamond-like surface. Diamond is, at its core, highly compressed, crystalized carbon. A massive cost reduction is possible by using a highly compressed carbon material that is not diamond but, for these purposes, shares very similar properties of high dielectric and the fabulous heat conduction of actual diamond.

An alternative to the diamond-like surface is aluminum nitride. It has about ⅙th the thermal conductivity of diamond or diamond-like material, but it still has a thermal conductivity of 310 W/mK (also denoted as (W/(m.K)) or Watts per meter-Kelvin) (sometimes referred to as k-value), nearly as good as gold, but, unlike gold, it is also an electrical insulator. It is lower in cost than diamond-like material and easier to find a supplier who can apply the coating, plus it still exceeds the thermal conductivity of the aluminum with which it might often be mated.

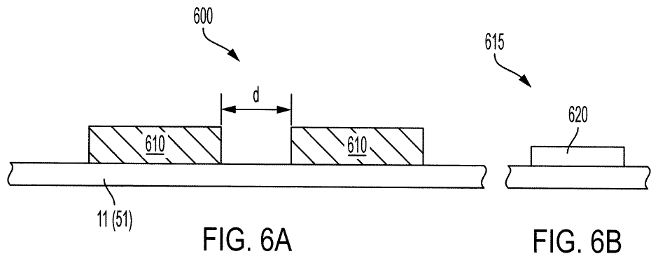

With reference to FIG. 6 (a), a portion 600 of a circuit board 11 or, in some embodiments, a heatsink 51, is shown having circuit traces 610. The circuit traces 610 to which the NRED devices are operatively soldered, provide the electrical conduction path to get the substantial DC electrical current to and from the NRED devices. Since it is the surface to which the NRED is soldered, the circuit trace 610 is that which is most intimately in contact with the devices themselves. In this regard, immediate heat spreading through an intimate thermally conductive material that is as close as possible to where the actual heat is produced inside the NRED semiconductor devices is provided by circuit traces 610. Another feature the presently described embodiments is the enlargement of the circuit trace pads 610 to the maximum possible size. In one example, the circuit traces are only slightly smaller than what would short them out to any neighboring pads or devices. In one example, the circuit trace pads are a distance D of approximately.050 inches apart. This provides a substantial amount of immediate heat spread which starts the process of keeping the NRED devices cool and is supported by the interrelated novelty of the balance of the presently described embodiments.

With reference to FIG. 6 (b), if standard sized circuit traces 620, such as those shown in portion 615 of a standard circuit board, which are only marginally larger than the semiconductor device itself, are employed, an opportunity is lost to do such immediate heat spreading. Also, the size of the circuit traces according to the presently described embodiments could be enlarged not only in length and/or width as alluded to above, but also in height, as representatively shown in FIG. 6 (b).

The next challenge in the heating chain deals with how to get the heat out of the circuit board itself. Another aspect of this novel systemic approach comes into play here. With continual heat input to the circuit board, it will continue to heat up until a path to either conduct, radiate, or convectively remove the heat is provided. It was determined that conduction would be the most proactive and efficient and could be made very manufacturable. It was determined that the circuit board itself could become a much larger thermal mass which would, by definition, not heat up as quickly. But nonetheless, for long cooking chores, it would heat up beyond acceptable limits.

In at least one form, the circuit board 11 is intimately in contact with an even larger thermal mass 51 which would be a heatsink. The interface between the thermally conductive circuit board 11 and the large thermal mass or heatsink 51, is also of high thermal conductivity. If both surfaces are very flat, a thermal grease 12 is applied between them to provide some level of full contact thermal conduction. Unfortunately, thermal grease, although very thin, is also a very poor thermal conductor. There are other products made for this purpose, but none of them are substantially better than the thermal grease. Nonetheless, it needs to be used to prevent having air gaps which provide even poorer thermal conduction because that small area of the circuit board must heat the air between the circuit board and the heatsink and then that air must transmit its heat to the top surface of the heatsink in that spot. Any amount of “air-gapping” is a very poor arrangement and will result in hot and cold spots on the circuit board and thus may cause devices to experience heat failure or at the very least would create hot and cold semiconductor components.

As mentioned, one way of providing at least some thermal conduction into the heatsink 51 is to use a thermal grease 12 or other intermediate material. It is also possible to manufacture the bottom surface of the circuit board and the top surface of the heatsink to be flat enough surfaces that they can be wrung together into intimate contact but this would be an extremely difficult and costly in the manufacturing process. It is also possible to use mating shapes on the bottom of the circuit board that would mate with the top surface of the heatsink and might use a metallic or other type of slurry which have higher conductivity components in them to provide for reasonably homogenous thermal conduction between them.

A more novel way of handling this is to effectively make the circuit board 11 extremely thick so that a thermal interface between the circuit board 11 and the heatsink 51 is not necessary. The portion of the circuit board then which is not being used for mounting semiconductor components, could be used to create a whole range of different types of convection surfaces. These convection surfaces could be slots or a whole range of different patterns of 3-D surfaces that would provide some level of natural convection or air turbulation to help dissipate heat. There has been much teaching and many white papers written on ways of shaping convection surfaces to maximize their heat exchange effectiveness. This design concept provides for a very thick circuit board that doubles as a heatsink, and avoids the heat conduction interface between the circuit board 11 and the heatsink 51.

Referring now to FIG. 2 (b), an alternative embodiment employs a heatsink 51, the top surface 53 of which is flat and can be coated with the diamond-like substance or aluminum nitride coating onto which circuit board traces can be attached and onto which the semiconductor NREDs 21 can be directly soldered. This provides for a novel mounting surface for the NREDs 21, facilitating high density mounting of the devices which can provide maximum heat dissipation and cooling for the individual NRED devices 21.

By providing an air tunnel, defined by radiative surfaces 55 and air circulation slots 56, attached to the bottom of these specially configured heatsinks 51, for more cooling, high-flow fans 70 can be fitted to provide plenty of forced convective airflow for effective cooling to dissipate the heat of the system into the surrounding ambient atmosphere. Again, the non-circuit-board portion of the heatsink 51 can have a wide variety of surfaces, e.g., surfaces 55 and slots 56, which can increase the thermal coupling to the surrounding air. High turbulation surfaces can be designed which will provide great surface area and terrific heat dissipation into either still-air or with the aid of fan-forced air.

Quiet, high-volume fans 70 with blades 72 can be fitted on either one or both ends of the convection tunnel to move large volumes of heat removing convective air, e,g., shown at 73, through the heatsink 51. The inner surface of the convection tunnel can be shaped to provide lots of flow turbulation to increase the thermal conduction coupling into the passing air. The fans 7-can be mounted on one end of the tunnel or both ends of the tunnel to create a push-pull configuration. If the tunnel can be oriented vertically, gravity convection can be used if the cooling requirements are not beyond a practical threshold.

This novel combination of “heatsink circuit board for a high density array of NREDs” can be operatively configured to work in conjunction with the cooling fans for many of the applications to which it may be applied. An alternative configuration, which would be more suitable for continuous, heavy-duty, or industrial applications, would utilize water cooling. For the more extreme applications, the water cooling could be enhanced by using a compressor-type chiller and coolant to reduce the water temperature to or below room temperature. It would be desirable to arrange the system however, so that the overall efficiency would permit a much simpler and lower cost water cooling system which would simply recirculate ambient temperature, non-refrigerated water with a pumped reservoir and heat exchanger arrangement. The water would circulate through the heat exchanger that is mounted in a thermally close-coupled way with the circuit board, or the top the heatsink may even function as the actual circuit substrate. A water based cooling stack could then consist of a pumped water circulation system through a heat exchanger and then through the heatsink. The heatsink, which is intimately thermally in surface to surface contact with the circuit board, and they could even be soldered together or more simply have thermal grease or other highly thermally conductive material between them. The heatsink would provide a thermal conduction path, thus pulling heat from the circuit board which has a dielectric coating atop it. In an anticipated ideal design, the dielectric is chosen to have a very high coefficient of thermal conduction, perhaps exceeding 700 W/mK. On top of the dielectric coating, the circuit traces would be bonded, to which the NRED devices are soldered. Each of these steps in the cooling stack is important and, depending on the rigor, environment, and duty cycle of the application, can be designed to higher performance levels of heat conductivity as needed to achieve the ultimate goal of the stack, of removing the excess heat that is produced by the NRED devices.

It is also possible to incorporate heat-pipe centric cooling technology to make the whole cooling arrangement even more effective, lower cost, and quieter. Using a technology that incorporates heat-pipe technology in concert with a micro-channel heat exchanger can be a very attractive option for high performance cooling in a very simple form factor. This arrangement, if implemented properly, could be much simpler and more effective than liquid cooling, while still providing massive amounts of effective stack cooling.

Some types of NRED devices, especially LED/RED devices, are manufactured with a lens built into the top surface of the device to narrow the output cone of optical energy. These lenses can be very helpful in many applications to facilitate concentrating and aiming the optical energy toward the target. Un-lensed NRED devices, especially LED/REDs, will have a native dispersion angle that is quite wide, for example it might be 150 degrees of included angle for the dispersion cone. Such devices that have built-in lensing may be narrowed to 70, 60, 50, 40, 30, 20 degrees or even as narrow as 10 degrees. Devices which are lensed differently can be placed accordingly to have higher intensity photonic energy at the far field target in chosen areas. The cone angle of dispersion must be chosen carefully so the gaussian output in the target plane has adequate overlap with the neighboring devices to have either the desired homogeneity or to require peaks and valleys or a custom pattern as required by a particular application. Using the more highly lensed devices will concentrate more directional energy on the target field and less energy around the perimeter of each array's output will be lost to a neighboring area.

If the right built-in lensing is unavailable it can be very desirable to position an engineered micro-lens array 31 just above the NRED array. A micro-lens array can be engineered such that there is a molded sheet of lenses 32 and a lens is positionally matched to each NRED device and will redirect the output photonic energy from each respective device according to effect an engineered irradiation pattern. Engineered and molded micro-lens arrays 31 will provide for far more custom aiming and flexibility than simply using lensed devices. Laser diodes are not typically available with built-in lenses, so micro-lens arrays provide high functionality for engineered aiming of laser diode arrays, especially VCSEL and SEDFB laser diode arrays. Laser diodes more typically than LED/REDs, will have a major and minor axis for their native output dispersion patterns. Therefore, it is possible and very desirable to design each lens in the micro-lens array so that it functions differently in each of the two axes. U.S. Pat. No. 11,184,955 teaches the design and use of engineered irradiation patterns attained from micro-lens arrays and engineered reflectors. The teachings of that patent are hereby incorporated herein by reference in its entirety and could be incorporated into an NRED oven to great advantage as an alternative to using integrally lensed devices.

A well-designed NRED oven should incorporate a protective glass isolation plate 61 which will be carefully chosen to transmit the photonic energy freely with minimum absorption, for the specific wavelengths that will be incorporated in the particular oven. It must be engineered to completely physically isolate and protect the NRED array and, if they are used, the micro-lens array 31 from contaminants and splatter. The plate 61 can be manufactured from carefully specified plastics, Ultem plastic, polycarbonate, or transparent ceramic. It should most ideally be manufactured from the correct glass, in order to handle the heat and sudden changes in heat from one area to another or from adjacent areas, it should be borosilicate glass or glass that is engineered to handle rapid and extreme heating load changes. NRED arrays and clusters of NRED arrays can be turned off and on in various random sequences which will cause extreme hot spots because of the passing of the photonic energy through one area while little or no energy is passing through an adjacent area. Standard glass and even most tempered glass will usually not handle these rapidly changing hot and cold areas and may break without warning and violently. It is also possible to use a special type of polymer which is highly transmissive at the NRED wavelengths being utilized and can handle the rapid thermal changes that may occur from one area of the protective plate to another. While most oven applications will utilize infrared wavelengths, some applications in processing ovens may dictate ultraviolet or visible light be used exclusively or augmented in addition to the IR light.

The isolation plate 61 should ideally be sealed with an elastomer or sealing element 63 around its perimeter to prevent contaminants whether in a solid, liquid, or vaporous form from working around and depositing on micro-lens arrays, NRED arrays, circuit board traces, sensors, power supplies, control electronics or any precision surfaces that are associated therewith. Care must be taken in the design to ensure that any thermal expansion or contraction of the isolation plate or the surrounding materials does not create leaks or gaps in the sealing arrangement and materials. The protective plate 61 should have an anti-reflective coating 62, specified for the employed wavelengths, which will allow more of the photonic energy to be transmitted through the plate. Without the anti-reflective coating, there will be about a 4% reflection off the plate and back at the arrays. It is hard to avoid the reflected energy from the target coming back toward the source and impacting the NRED devices, circuit board, and the surrounding circuit areas of the arrays and thus causing undesirable additional heat.

The elastomer element 63 that is used to seal around the perimeter must be capable of not only providing a tight if not hermetic seal, but also handling the heat and the direct contact with the target item off-gassing, comestible off-gassing, splatter, and various contaminants. It must also be able to tolerate the irradiation energy that will be impacting it either directly or from reflections.

The photonic energy that is aimed and projected toward the target, whether a comestible or another item to be heated or cured, does not all penetrate the target upon impact. Depending on the nature of the target, some will penetrate into it, some will be scattered randomly, some will be reflected, some will simply burn or brown the surface. Even when using the carefully chosen wavelength at which there is relatively little absorption and high transmission, this is the cause. For example, a piece of chicken may have over 50% reflection/scatter. The ratio of penetration and reflection/scatter may also change at different stages of the cooking process. In any event, the photons that do not penetrate the target or burn its surface will be directed, reflected, or scattered away from the target and will impact other surfaces in the interior of the oven space or cooking cavity. To preserve and not waste this photonic energy by heating items other than the intended target, reflective material can line the oven cavity. Ideally corner cube reflection sheet can be used for this purpose, because it will improve the overall system efficiency by sending energy back to its target reflection or scatter point.

Reflective sheeting 41 can be made with cutouts or punch-outs exactly matching each of the NRED array devices 21, such that the reflective material covers all or much of the circuit board 11 that is not covered by NRED semiconductor devices 21. These windows, through which the NREDs 21 may protrude, allow the photons that are produced by them to be directed toward the target and unimpeded. It can function as a reflector so that any returning photons which have bounced off the target, may be redirected back into the oven cavity where they may hit the target again. As an alternative approach, strips of corner-cube sheeting material 41 can be applied to the circuit board between the devices if there is very little space between the devices in one direction and space available in the other direction. By comparison, a simple reflector will very likely not send the errant photons back to the target unless it happens to be perfectly oriented and that orientation is only useful from a certain angle of incidence. The angle of incidence equals the angle of reflection off a flat reflector surface. Certainly, an engineered non-flat reflector can be designed for such situations, but again, the angle of incidence to the engineered reflector must be perfect, which makes this solution less than ideal in many situations. A much superior solution in these applications is to use a corner-cube sheeting material 41 as the reflector. This will effectively return the photonic ray back to very close to the point on the target off of which the reflection came. It truly acts as a reflector that will return the ray back exactly from its source, on a parallel line to the exact ray direction from which it came as it reflected off the target and the corner-cube sheet material has an input acceptance angle of plus or minus 45 degrees.

Corner-cube sheeting 41 is configured as an array of thousands of small three sided “cube” reflectors that have the unique feature of returning or reflecting photonic energy back to or very close to the source from which the photons were most recently reflected or originated. U.S. Pat. No. 11,774,648 details and explains how corner-cubes function and is incorporated herein by reference in its entirety. A variation on the corner-cube sheeting is known by some as near or imperfect corner-cubes which have one or more of the three perpendicular sides of each cube configured at not perfect 90 degree angles. The result is the reflections do not return precisely along parallel rays to the input photons but are slightly out of parallel to provide a slight diversive reflection. Their reflection only approximates a reflection directly back to the recent source that is useful but not precise. Both types of “corner-cube” constructions can be very useful in this invention, depending on the exact application.

The concepts taught here as to how to implement the presently described embodiments, are intended to help one who wants to configure the presently described embodiments for his specific application and production needs. The examples will show how there are many different ways of implementing the presently described embodiments well beyond the specific examples given. An individual or a team skilled in the respective arts will be able to extend the novel concepts to meet their unique application requirements accordingly.

We claim:

1. An oven system for curing, cooking, heating, thawing or holding at temperature, the system being designed to provide an irradiation location to heat at least one of a target item or comestible, the system comprising:
at least one array of narrowband radiation emitting devices (NREDs) configured to produce at least 6 watts per square inch of infrared energy measured at a target plane, the at least one array of NREDs supplying at least 6 watts per square inch of optical energy to each of at least 12 square inches of the target plane, wherein at least one of the NREDs is provided with a corresponding lens or engineered reflector and wherein at least one of the NREDs in the at least one array produces narrowband photonic output between 720 and 1180 nanometers;
a substrate upon which the at least one array of NREDs is mounted, the at least one array of NREDs being arranged on the substrate formed of a thermally transmissive material, wherein the material has an index of thermal conductivity of at least 160 W/mK;
circuit traces formed on the substrate, the NREDs being soldered to the traces, wherein the traces dissipate heat generated by the NREDs soldered to the traces;
a structure configured to hold the at least one array of NREDs and the substrate upon which the at least one array of NREDs is mounted in a predetermined position in the system and to provide a platform to support the target or comestible item for irradiation;
a protective plate formed of at least one of glass, plastic, or transmissive ceramic material and being positioned between the target item or comestible and the at least one array of NREDs and one of the corresponding lenses and the engineered reflectors, wherein the protective plate is at least 85% optically transmissive at the wavelength produced by the NRED devices, and wherein the protective plate includes a sealing element around a perimeter of the protective plate arranged to cooperate with the structure to seal out contaminants from reaching the at least one NRED array and the corresponding lenses;
an air movement space between the protective plate and any of the at least one array of NREDs, the circuit board substrate, and one of the corresponding lenses and the engineered reflectors to provide a path for removal of heat from the at least one array of NREDs;
at least one fan positioned to generate air flow to remove heat from any of the at least one array of NREDs, the circuit board substrate, the corresponding lenses, and the air space; and,
a control system operatively connected to at least one DC power supply, the at least one DC power supply being operatively connected to the at least one array of NREDs and capable of continuously controlling the amperes of electrical current being supplied thereto or a power supply which is used in conjunction with at least one electrical component which limits the current to the at least one array of NREDs.

2. The system as set forth in claim 1, wherein the corresponding lens is an array of lenses which are arranged in an engineered micro-lens array whose spacing corresponds to the spacing of the NRED devices of the array and which can steer the energy according to a desired energy distribution pattern.

3. The system as set forth in claim 1, wherein the corresponding lenses are formed integrally to each NRED device and focus the output to approximately one of a 70 degree angle, a 60 degree angle, a 50 degree angle, a 40 degree angle, a 30 degree angle and a 10 degree angle.

4. The system as set forth in claim 1, wherein the oven is configured to position at least two stacks, each stack comprising the at least one array, the substrate, the protective plate and the at least one fan, on at least two sides or top and bottom of the irradiation platform to facilitate irradiation from two approximately opposite directions, facilitating using less power from each direction but providing better distribution through the target item or comestible item.

5. The system as set forth in claim 1, wherein the circuit traces are provided on the substrate such that dimensions of the circuit traces are enlarged in the large plane of the substrate to a maximum practical extent before the circuit traces cause shorting to neighboring traces, in order to spread and dissipate heat produced by the NREDs more quickly and directly from a soldered base of each device.

6. The system as set forth in claim 1, wherein the system comprises multiple substrates, each substrate having at least one array of NREDs mounted thereon defining a circuit board, the circuit boards being designed so that the circuit boards can be mounted side-by-side to facilitate at least one of array mounting symmetry, minimize non-homogeneity in target plane power, and zone positioning flexibility, such that the circuit boards would be configured accordingly in both the x and y directions as relates to the large plane of each respective circuit board.

7. The system as set forth in claim 6, wherein, when multiple circuit boards with heatsinks are used, the circuit boards are designed so that they can be mounted side-by-side to facilitate at least one of array mounting symmetry, minimize non-homogeneity in target plane power, and zone positioning flexibility, such that the circuit boards would be configured accordingly in both the x and y directions as relates to the large plane of each respective circuit board.

8. The system as set forth in claim 1, wherein a majority of the NREDs produce their narrowband output between 720 and 1180 nanometers but at least one NRED are incorporated which produce their narrowband output between 1360 and 1560 nanometers in order to be absorbed nearer the surface of a comestible target.

9. The system as set forth in claim 1, wherein at least one NRED are incorporated which produce their narrowband output between 1360 and 1560 nanometers in order to be absorbed nearer the surface of a comestible target.

10. The system as set forth in claim 1, comprising reflective surfaces configured to direct stray irradiation to the target item and corner cube reflectors to redirect irradiation reflected from the target item back to the target item.

11. The system as set forth in claim 1, wherein the at least one array of NREDs comprises one of two arrays of NREDs, four arrays of NREDs, six arrays of NREDs or eight arrays of NREDs.

12. The system as set forth in claim 1, wherein each of the at least one array of NREDs is controlled by a different current to provide varying amounts of power.

13. The system as set forth in claim 1, wherein a stack comprises the at least one array, the substrate, the protective plate and the at least one fan, wherein the stack is mounted above a heating zone, wherein the structure provides a space below for the comestible, and wherein irradiation is aimed generally downward such that the irradiation is absorbed by the comestible directly so as to not pass through any plating item on which the comestible is placed before hitting the comestible.

14. The system as set forth in claim 1, wherein the 12 square inches of target plane comprises 12 contiguous square inches.

15. The system as set forth in claim 1, wherein the DC power supply is comprised of a battery which is recharged from one of an alternating current source and a solar panel arrangement.

16. The system as set forth in claim 1, wherein the oven system is configured to produce one of at least 20 Watts/Square Inch, 40 Watts/Square Inch, 60 Watts/Square Inch, or 100 Watts/Square Inch at the target plane.

17. The system as set forth in claim 1, wherein the oven system is configured to produce one of at least 60 Watts/Square Inch, 100 Watts/Square Inch, 120 Watts/Square Inch, or 140 Watts/Square Inch to at least 20 contiguous square inches of the target plane.

18. An oven system for curing, cooking, heating, thawing or holding at temperature, the system being designed to provide an irradiation location to heat at least one of a target item or comestible, the system comprising:
at least one array of narrowband radiation emitting devices (NREDs) configured to produce at least 6 watts per square inch of narrowband infrared energy at a target plane,
wherein the at least one array of NREDs supplying at least 6 watts per square inch of narrowband infrared energy to each of at least 12 square inches of the target plane,
wherein at least one of the NREDs is provided with a corresponding lens or engineered reflector and
wherein at least one of the NREDs in the at least one array produces peak narrowband infrared energy output between 720 and 1180 nanometers;
at least one heatsink, in lieu of a separate circuit board, upon which the at least one array of NREDs is mounted, wherein the at least one heatsink material has a thermal coefficient of conductivity of at least 205 W/mK, wherein the at least one heatsink is at least ten times the mass of the separate circuit board, wherein the at least one heatsink provides substantially increased surface area compared to a surface of a separate circuit board thereby providing much more heat absorption and dissipation and facilitating more surface area for radiant cooling to surrounding ambient air and wherein a surface of the at least one heatsink which is used for mounting the NREDs is a substantially flat surface and has been coated with an electrically insulative but thermally conductive coating;
circuit traces applied directly to a surface of the electrically insulative but thermally conductive coating, the NREDs being soldered directly to the circuit traces, wherein the traces are thermally conductive and dissipate heat generated by the NREDs soldered to the traces on the substrate;
a structure configured to hold the at least one array of NREDs and the heatsink upon which the at least one array of NREDs is mounted in a predetermined position in the system and to provide a platform to support the target or comestible item for irradiation;
a protective plate formed of at least one of glass, plastic, or transmissive ceramic material and being positioned between the target item or comestible and the at least one array of NREDs and corresponding lenses, wherein the protective plate is at least 82% optically transmissive at the wavelength produced by the NRED devices, and wherein the protective plate includes a sealing element around a perimeter of the protective plate arranged to cooperate with the structure to seal out contaminants from reaching the at least one NRED array and the corresponding lenses;
an air movement space between the protective plate and the at least one array of NREDs and one of the corresponding lenses and the engineered reflectors to provide a path for removal of heat from the at least one array of NREDs;
at least one fan positioned to generate air flow to remove heat from at least one of the array of NREDs, the circuit substrate, and one of the corresponding lenses and the engineered reflectors, and,
a control system operatively connected to at least one DC power supply, the at least one DC power supply being operatively connected to the at least one array of NREDs and capable of continuously controlling the amperes of electrical current being supplied thereto or a power supply which is used in conjunction with at least one electrical component which limits the current to the at least one array of NREDs.

19. The system as set forth in claim 18, wherein the corresponding lens is comprised of in an engineered micro-lens array providing the functionality of steering the energy from many of the respective NRED devices to form an overall desired energy distribution pattern.

20. The system as set forth in claim 18, wherein the corresponding lens is comprised of an integrally formed lens to many of the narrowband radiation emitting devices and focus the respective device's output to one of approximately: a 70 degree angle, a 60 degree angle, a 50 degree angle, a 40 degree angle, a 30 degree angle and a 10 degree angle.

21. The system as set forth in claim 18, wherein the protective plate is made of borosilicate glass and includes an anti-reflective coating on both sides such that transmissivity is at least 98%.

22. The system as set forth in claim 18, wherein the electrically insulative but thermally conductive coating that is applied on the at least one heatsink is one of aluminum nitride, diamond-like coating, and diamond coating for extreme heat conduction of the heat from the NRED devices wherein the thermal conductivity of the coating is greater than 300 W/mK.

23. The system as set forth in claim 18, wherein the protective plate integrates with the structure and sidewalls of the oven system to seal out contaminants so the contaminants cannot reach any of the at least one array of NREDs, circuit traces, the corresponding lenses, power supplies and other sensitive components, and such that there is a drain arrangement associated with the protective plate to carry away liquid contaminants.

24. The system as set forth in claim 18, wherein the oven is configured to position at least two stacks, each stack comprising the at least one array, the at least one heatsink, the protective plate and the at least one fan, on at least two sides or top and bottom of the irradiation platform to facilitate irradiation from two approximately opposite directions, facilitating using less power from each direction but providing better distribution through the target item or comestible item.

25. The system as set forth in claim 18, wherein the oven is configured such that the structure includes sidewalls which are strategically angled and the sidewalls are strategically covered with at least one of corner cube reflection sheet or approximate corner cube reflection sheet, the angles and configuration of which are arranged for efficient return of reflected or scattered energy that has come from the target but is reflected back to the target item, and which corner-cube reflection sheet is provided with a smooth surface facing the target item to provide for ease of cleaning.

26. The system as set forth in claim 18, wherein the at least one NRED array is provided with one of a corner cube sheet or a reflective sheet with holes provided through which the NRED devices can project energy and provide for efficient reflection of NRED optical energy, originally directed to the target item or comestible then reflected away, back to the target item to increase overall heating efficiency.

27. The system as set forth in claim 18, wherein the circuit traces are provided on the heatsink such that dimensions of the circuit traces are enlarged in the large plane of the heatsink to a maximum practical extent before the circuit traces cause shorting to neighboring traces, in order to spread and dissipate heat produced by the NREDs quickly and directly from a soldered base of each device.

28. The system as set forth in claim 18, wherein the at least one heatsink comprises multiple heatsinks, each heat sink having at least one array of NREDs mounted thereon, the heatsinks being designed so that the heatsinks can be mounted side-by-side to facilitate at least one of array mounting symmetry, minimize non-homogeneity in target plane power, and zone positioning flexibility, such that the heatsinks would be configured accordingly in both the x and y directions as relates to the large plane of each respective heatsink.

29. The system as set forth in claim 18, wherein a majority of the NREDs produce their narrowband output between 720 and 1180 nanometers but at least one NRED are incorporated which produce their narrowband output between 1360 and 1560 nanometers in order to be absorbed nearer the surface of a comestible target.

30. The system as set forth in claim 18, wherein the NREDs that produce their narrowband output between 1360 and 1560 are mounted in such a manner that their output can be one of scanned over the surface of the comestible and directed to the comestible target differently than the other narrowband NRED devices.

31. The system as set forth in claim 18, wherein the system is configured such that the target item can be moved through the irradiation platform zone for irradiation.

32. The system as set forth in claim 18, wherein completely different sequential digital irradiation programs can be delivered from each NRED array or section of an array.

33. The system as set forth in claim 18, wherein at least one NRED are incorporated which produce their narrowband output between 1360 and 1560 nanometers in order to be absorbed nearer the surface of a comestible target.

34. The system as set forth in claim 18, comprising reflective surfaces configured to direct stray irradiation to the target item and corner cube reflectors to redirect irradiation reflected from the target item back to the target item.

35. The system as set forth in claim 18, wherein the at least one array of NREDs comprises one of two arrays of NREDs, four arrays of NREDs, six arrays of NREDs or eight arrays of NREDs.

36. The system as set forth in claim 18, wherein each of the at least one array of NREDs is controlled by a different current to provide varying amounts of power.

37. The system as set forth in claim 18, wherein the 12 square inches of target plane comprises 12 contiguous square inches.

38. The system as set forth in claim 18, wherein the DC power supply is comprised of a battery which is recharged from one of an alternating current source and a solar panel arrangement.

39. The system as set forth in claim 18, wherein the circuit traces are enlarged in thickness and substantially beyond the footprint of the NRED devices to provide additional heat dissipation such that traces are enlarged to within 0.050″ of neighboring traces.

40. The system as set forth in claim 18, wherein there is a gutter drainage arrangement that is adjacent to at least part of a perimeter of the protective plate and provides a path that gravity can use to drain away to a safe area any liquid contaminant that might be on the surface of the protective plate.

41. An oven system for curing, cooking, thawing or heating, the system being designed to provide an irradiation platform location to heat at least one of a target item or comestible, the system comprising:
at least one array of narrowband radiation emitting devices (NREDs) configured to produce at least 6 watts per square inch of infrared energy measured at a target plane, the at least one array of NREDs supplying at least 6 watts per square inch of optical energy to each of at least 12 square inches of the target plane, wherein at least one of the NREDs is provided with a corresponding lens or engineered reflector and wherein at least one of the NREDs in the at least one array produces narrowband photonic output between 720 and 1180 nanometers;
a substrate upon which the at least one array of NREDs is mounted, the at least one array of NREDs being arranged on the substrate formed of a thermally transmissive material, wherein the material has an index of thermal conductivity of at least 160 Watts/K-Meter, wherein the substrate has a dielectric material thereon;
circuit traces formed on the substrate, the circuit traces being insulated from the substrate by dielectric material, the NREDs being soldered to the traces, and the traces being configured to dissipate heat generated by the NREDs soldered to the traces;
a heatsink having at least ten times the mass of the substrate, wherein the heatsink is intimately in contact with and is sized similarly to a bottom of the substrate, an interface between the heatsink and the substrate being coated with thermal grease to increase a thermal conduction into the heatsink, wherein the heatsink is formed of a material having a thermal coefficient of conductivity of at least 205 Watts/K-Meter and wherein the heatsink provides the system with substantially increased surface area, for more heat absorption and dissipation and facilitating more surface area for radiant cooling to surrounding ambient air;
a structure configured to hold the at least one array of NREDs, the substrate upon which the at least one array of NREDs is mounted, and the heatsink in a predetermined position in the system and to provide a platform to support the target or comestible item for irradiation;
a protective plate formed of at least one of glass, plastic, or transmissive ceramic material and being positioned between the target item or comestible and the at least one array of NREDs and corresponding lenses, wherein the protective plate is at least 88% optically transmissive at the wavelength produced by the NRED devices, and wherein the protective plate includes a sealing element around a perimeter of the protective plate arranged to cooperate with the structure to seal out contaminants from reaching the at least one NRED array and the corresponding lenses;
an air space between the protective plate and the at least one array of NREDs and the corresponding lenses to provide a path for removal of heat from the at least one array of NREDs;
at least one fan positioned to generate air flow to remove heat from at least one of array of NREDs, the substrate, the corresponding lenses, and the air space, wherein the at least one fan is positioned to generate air flow through surface-area-increasing turbulation channels in the heatsink and through the air space to remove heat produced by the at least one NRED array; and,
a control system operatively connected to at least one DC power supply, the at least one DC power supply being operatively connected to the at least one array of NREDs and capable of continuously controlling the amperes of electrical current being supplied thereto or a power supply which is used in conjunction with at least one electrical component which limits the current to the at least one array of NREDs.

42. The system as set forth in claim 41, wherein the system is configured with more than one NRED array and each NRED array can be controlled separately and may be aimed at a target area zone that is one of the same area, partially overlapping areas, and completely different areas.

43. The system as set forth in claim 42, wherein different power levels can be delivered to different zones from either whole NRED arrays or sub-sections of NRED arrays to achieve desired results in each zone.

44. The system as set forth in claim 43, wherein completely different sequential digital irradiation programs can be delivered from each NRED array.

45. The system as set forth in claim 41, wherein the oven system is configured to produce one of at least 40 Watts/square inch, 60 Watts/Square Inch, 100 Watts/Square Inch, 120 Watts/Square Inch, or 140 Watts/Square Inch to at least 20 square inches of target area.

46. The system as set forth in claim 41, wherein the oven system is configured to position two stacks, each stack comprising the at least one array, the circuit board substrate, the heatsink, the protective plate and the at least one fan, on at least two sides of the irradiation platform to facilitate irradiation from two or more directions, which could be top and bottom or could be side to side or another direction, but facilitating irradiation from at least two directions, providing better distribution through the target or comestible item and providing that a different amount of energy can be delivered from each side.

47. The system as set forth in claim 41, wherein the circuit traces for each respective NRED are enlarged substantially beyond the footprint of the NRED devices to provide additional heat dissipation and such that some of the traces are enlarged to within 0.050″ of a neighboring trace.

48. The system as set forth in claim 41, wherein there is a gutter drainage arrangement adjacent to at least part of a perimeter of the protective plate and provides a path, that gravity can use to drain away to a safe area, any liquid contaminant that might be on the surface of the protective plate.

49. The system as set forth in claim 41, wherein the protective plate is made of borosilicate glass and has been anti-reflective coated on both sides such that transmissivity is at least 98%.

50. The system as set forth in claim 41, wherein a majority of the NREDs produce their narrowband output between 720 and 1180 nanometers but at least one NRED devices are incorporated which produce their narrowband output between 1360 and 1560 nanometers in order to be absorbed nearer the surface of a comestible target.

51. The system as set forth in claim 41, wherein the protective plate is made of borosilicate glass and includes an anti-reflective coating on both sides such that transmissivity is at least 98%.

52. The system as set forth in claim 41, wherein completely different sequential digital irradiation programs can be delivered from each NRED array or section of an array.

53. The system as set forth in claim 41, wherein at least one NRED devices are incorporated which produce their narrowband output between 1360 and 1560 nanometers in order to be absorbed nearer the surface of a comestible target.

54. The system as set forth in claim 41, comprising reflective surfaces configured to direct stray irradiation to the target item and corner cube reflectors to redirect irradiation reflected from the target item back to the target item.

55. The system as set forth in claim 41, wherein the at least one array of NREDs comprises one of two arrays of NREDs, four arrays of NREDs, six arrays of NREDs or eight arrays of NREDs.

56. The system as set forth in claim 41, wherein each of the at least one array of NREDs is controlled by a different current to provide varying amounts of power.

57. The system as set forth in claim 41, wherein the oven system is configured such that the at least 12 square inches to which is delivered the narrowband infrared energy is at least 40 contiguous square inches of target plane area.

58. The system as set forth in claim 41, wherein the oven system is configured to circulate water through the heatsink as an alternate way of providing enough cooling to the NRED devices.

59. The system as set forth in claim 41, wherein the 12 square inches of target plane comprises 12 contiguous square inches.
